(19) United States
(12) Patent Application Publication
(10) Pub. No.: US 2026/0009146 A1
(43) Pub. Date: Jan. 8, 2026

(54) COBALT ON TUNGSTEN TITANIUM CARBIDE MXene

(71) Applicant: IOWA STATE UNIVERSITY RESEARCH FOUNDATION, INC., Ames, IA (US)

(72) Inventors: Yue WU, Ames, IA (US); Fan YANG, Fuzhou City, Fujian Province (CN); Xiaopeng LIU, Ames, IA (US)

(73) Assignee: IOWA STATE UNIVERSITY RESEARCH FOUNDATION, INC., Ames, IA (US)

(21) Appl. No.: 19/263,062

(22) Filed: Jul. 8, 2025

Related U.S. Application Data
(60) Provisional application No. 63/668,528, filed on Jul. 8, 2024.

(51) Int. Cl. C25B 11/075; C01B 32/90; C25B 1/02

(52) U.S. Cl. CPC C25B 11/075; C01B 32/90; C25B 1/02; C01P 2002/72; C01P 2002/85; C01P 2004/03; C01P 2004/04

(57) ABSTRACT

We synthesized a tungsten titanium carbide (W₂TiC₂) MXene. By loading cobalt onto the surface of W₂TiC₂, we developed an effective and stable catalyst for an alkaline hydrogen evolution reaction. The catalyst exhibited a small overpotential of 63 mV at 10 mA/cm² and a low Tafel slope of 44.3 mV/dec. At high current density of 100 mA/cm² and 1000 mA/cm², low overpotentials of 191 mV and 408 mV were achieved, outperforming commercial Pt/C electrodes. Under both current ranges, our catalyst exhibited excellent stability of 500 h at 10 mA/cm² and for 100 h at 1000 mA/cm² without any degradation. In flow cell tests, by pairing with Ni foam, our catalyst required much lower cell voltage than commercial Ni foam Pt/C and maintained ˜100% H₂ faradaic efficiency over 15 h of continuous tests from 50 to 400 mA/cm². Under more demanding industry-level conditions, the catalyst maintains the incredible performance, exhibiting an excellent stability of at least 1000 h at 4000 mA cm⁻² in 1 M KOH.

### RELATED APPLICATIONS

This application claims priority under 35 U.S.C. § 119(e) to U.S. Provisional Patent Application No. 63/668,528, filed Jul. 8, 2024, which is incorporated herein by reference.

### BACKGROUND OF THE INVENTION

Hydrogen (H₂) has long been considered the most promising candidate to replace fossil fuels due to its high energy density and carbon-neutral nature. Electrochemical water splitting, when synergistically combined with electricity derived from renewable resources, holds great potential in achieving zero-carbon emission, which is considered a crucial method for sustainable production of green H₂. In this context, several nations have defined strategies to support hydrogen production through regulations, fundings, and tax programs. According to the projections made by the International Energy Agency (IEA), water electrolyzers with a capacity of 720 GW are needed by the year 2030 to follow the path towards the net zero greenhouse gas emissions by the year 2050, with a projected required capacity of 3670 GW in the year 2050. While achieving these projections is an ambitious goal for the current petroleum-based energy sector, developing efficient, durable, and affordable electrode materials for “green” hydrogen production can help maintain the globally averaged temperature rise below 1.5° C. by the year 2050.

Currently, conventional water electrolysis is usually performed under acidic conditions using proton exchange membrane (PEM) electrolyzers or under alkaline conditions through alkaline water electrolysis (AWE). PEM electrolysis uses a solid polymer membrane to conduct protons, enabling high current densities, fast response times, and compact system design, which is well-suited for dynamic renewable energy input. Nevertheless, acidic water electrolysis using PEM systems for H₂ production generally requires expensive noble metal catalysts like platinum (Pt) and iridium (Ir), as well as extremely costly proton exchange membranes. Moreover, the system durability issues and sluggish oxygen evolution reaction (OER) kinetics under acidic conditions also greatly limit the full utilization of acidic hydrogen evolution reaction (HER) in industrial applications. Notably, alkaline water electrolysis can effectively circumvent many of the issues associated with acidic systems, and the relevant commercial technologies have been well developed for large-scale industrial H₂ production.

While numerous advanced materials have been developed to enhance the electrocatalytic HER under alkaline conditions, these catalysts still exhibit many limitations, particularly at high current densities, including high energy cost related to overpotential, slow HER kinetics due to the strong adsorption of hydroxide (OH⁻) species on active sites hindering the H₂ adsorption, limited durability under industrially relevant currents, and structural instability over prolonged electrolysis operation. Therefore, the rational design of stable, low-cost catalysts that maintain high activity in alkaline electrolytes at high current densities is essential for advancing the commercialization of alkaline HER technologies.

In this regard, Co-based electrocatalysts have risen to prominence benefiting from their cost-effectiveness, reduced environmental impact, good catalytic activity, and structural diversity. When combined with other materials such as carbon-based materials or transition metals, Co-based catalysts can exhibit synergistic effects that enhance not only their HER activity but also stability. Extensive research has been dedicated to developing cobalt related composite structures with transition metal oxides, sulfides, phosphides, carbides, and hydroxides; however, few studies have demonstrated good performance with comprehensive coverage across a wide range of current densities (e.g., from 10 mA cm⁻² to higher than 1 A cm⁻²) while also achieving long-term stability under such conditions, such as exceeding 100-500 hours. Meanwhile, metal-carrier interaction (MSI) can induce hybridization of electronic orbitals to modulate the charge transfer between the metal and the support, which could further improve the electrocatalytic activity. The strong interaction between the catalyst and the support can also anchor the particles or single-atom catalyst to effectively reduce the aggregation of active species during the HER process.

MXenes are a family of 2D early transition metal carbides, nitrides, and carbonitrides (ACS Nano 2019, 13, 8491-8494). As catalyst support with metallic conductivity, MXenes can significantly enhance charge transfer and increase surface area with exposed active sites. Together with the high hydrophilicity and good chemical stability under reactive conditions, MXenes have been widely applied in electrocatalysis with capability to modulate the geometric and electronic properties of metal catalyst through various MSI.

Accordingly, there is an urgent need for an efficient means to generate hydrogen as a clean energy source to combat energy shortages and global warming.

### SUMMARY

In this work, we report a non-noble metal based HER catalyst by dispersing sub-nanometer Co on a novel MXene (Co/W₂TiC₂), the catalytic performance of our Co/W₂TiC₂ catalyst was not only evaluated at low current densities relevant to direct solar driven water splitting (10 mA cm⁻²), but also at industrial electrochemical AWE level (4000 mA cm⁻²). In 1 M KOH, the catalyst showed a low overpotential of only 63 mV at 10 mA cm⁻² with a Tafel slope of 44.3 mV dec⁻¹ and exhibited excellent stability for 500 h under such current density. At 1000 mA cm⁻², it delivered an overpotential of 408 mV and a high stability of 500 h. Under more demanding industry-level conditions, the catalyst maintains the incredible performance, exhibiting an excellent stability of at least 1000 h at 4000 mA cm⁻² in 1 M KOH using a 1×1 cm² flow cell electrolyzer. Our density functional theory (DFT) calculations, in conjunction with X-ray absorption near edge structure (XANES) studies, identified interfacial Co—W sites as the likely active site. Our results showed a strong correlation between the d-band center of interfacial W atoms and hydrogen adsorption strength, indicating a strong structurally modulated metal-support interaction at Co—W interfaces.

Accordingly, this disclosure provides an annealed catalyst comprising a delaminated MXene support of Formula I:

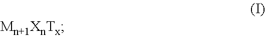

wherein
   M is a combination of a middle transition metal and an early transition metal;
   X is a non-metal wherein the non-metal is carbon or nitrogen;
   Tₓ is a surface functional group wherein x is 0-10; and
   n is 2 or 3; and
late transition metal nanoparticles having a particle size of about 0.5 nm to about 2.0 nm, wherein less than 5 weight percent of the late transition metal nanoparticles are uniformly distributed onto a basal plane of the MXene support based on the weight of the catalyst;
wherein metal support interactions at an interface of atoms of the late transition metal nanoparticles and atoms of the middle transition metal are present in the catalyst.

This disclosure provides a delaminated MXene support of Formula II:

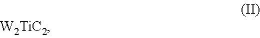

wherein the delaminated MXene support is composed of alternating layers of transition metals and carbon, such that two carbon layers are sandwiched between three metal layers, wherein titanium occupies the middle metal layer and tungsten occupies the top and bottom layers.

Additionally, this disclosure also provides a method for an electrocatalytic hydrogen evolution reaction comprising:
a) contacting an alkaline aqueous electrolyte with a catalyst loaded onto a cathode, wherein the catalyst was annealed at about 700° C. and comprises:
   i) a delaminated MXene support of Formula II:

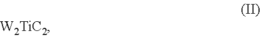

wherein the delaminated MXene support comprises a layer of tungsten atoms, a layer of carbon atoms, and a layer of titanium atoms that alternate in the sequence W—C—Ti—C to form a layer of titanium atoms in-between two layers of carbon atoms that are sandwiched together between two layers of tungsten atoms; and
   ii) cobalt metal nanoparticles having a size of about 0.8 nm to about 1.0 nm, wherein about 3.5 weight percent to about 4.5 weight percent of the cobalt metal nanoparticles are uniformly distributed onto a basal plane of the MXene support based on the weight of the catalyst; and
b) applying a current to the cathode;
   wherein an electrocatalytic reaction occurs at the cathode to form the evolution of hydrogen gas.

The invention provides novel compositions of Formula I and Formula II, intermediates for the synthesis of compositions of Formula I and Formula II, as well as methods of preparing compositions of Formula I and II. The invention also provides compositions of Formula I and II that are useful as intermediates for the synthesis of other useful compositions. The invention provides for the use of compounds of Formula I and Formula II for the energy efficient manufacture of hydrogen gas.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1A-E. Synthesis steps of W₂TiC₂Tₓ and Co/W₂TiC₂.(a) Schematic illustration of the sintering, etching, delamination steps of MXene synthesis, and metal loading and annealing process of Co/W₂TiC₂ catalyst synthesis; (b) XRD patterns of W₂TiAlC₂, W₂TiC₂Tₓ and delaminated W₂TiC₂Tₓ MXene (d-W₂TiC₂Tₓ) with peak assignments for each phases; (c) SEM image of W₂TiAlC₂ precursor; (d) SEM image of W₂TiC₂Tₓ MXene; (e) TEM image of W₂TiC₂Tₓ showing the layer structure.

FIG. 2. Structure characterization of Co/W₂TiC₂. (a) XRD patterns of W₂TiAlC₂ and Co/W₂TiC₂ catalysts annealed at 500, 600, and 700° C.; (b) SEM image of Co/W₂TiC₂ catalyst; (c) TEM image from the top view of a Co/W₂TiC₂ piece (inset: selected area electron diffraction pattern); (d) TEM image of Co/W₂TiC₂ catalyst shows clear lattice fridges (right: inverse fast Fourier transform image and lattice fridge measurement); (e) Atomic resolution HAADF-STEM image showing structure of W₂TiC₂ MXene. The two-dimensional structure of W₂TiC₂ featuring orderly arranged metal layers was clearly presented from the side-view STEM image.

FIG. 3A-K. XPS, XANES, and EXAFS studies of Co/W₂TiC₂ catalysts. (a) W 4f, (b) Ti 2p, and (c) Co 2p XPS spectra of W₂TiC₂Tₓ and Co/W₂TiC₂ annealed at 500, 600, and 700° C.; (d) Nexsa G2 live optical view of Co/W₂TiC₂-700 sample for ion scattering spectroscopy (ISS) spectra; (e-h) Co K-edge XANES from 7.700 to 7.750 keV of (e) Co Foil, CoO, and Co500; k²-Weighted and the magnitude (solid) and imaginary (dash) part of the Fourier transform of the Co K edge EXAFS of (f) Co foil, (g) CoO reference, and (h) Co/W₂TiC₂-700; (i) 1 keV He⁺ ISS spectra from Co/W₂TiC₂-700; (j) The Co K edge XANES spectra and (k) the magnitude of the Fourier Transform of the k² weighted Co K-edge of the Co/W₂TiC₂ catalyst annealed at 500, 600, and 700° C.

FIG. 4A-I. Electrochemical characterizations. (a) Linear sweep voltammetry (LSV) curves of W₂TiC₂Tₓ, Co/WC and Co/W₂TiC₂ annealed at 500, 600, and 700° C. in N₂ saturated 1 M KOH; (b) Magnified LSV polarization curves at 0˜−10 mA cm⁻² current density; (c) Overpotentials comparison of the Co/W₂TiC₂-500, 600, and 700 catalysts with W₂TiC₂Tₓ, Co/WC, and commercial Pt/C at same loading mass (0.5 mg cm⁻²) at 10 A cm⁻², 50 A cm⁻², and 100 A cm⁻². The error bars are standard deviations from 3 replicates. (d) Tafel slopes of W₂TiC₂Tₓ, Co/WC and Co/W₂TiC₂ annealed at 500, 600, and 700° C. (e) Nyquist plots of W₂TiC₂Tₓ, Co/WC and Co/W₂TiC₂ catalysts in N₂ saturated 1 M KOH (inset: fitted circuit); (f) Comparison of the HER performance in alkaline conditions of Co/W₂TiC₂-700 over other cobalt-based and transition metal carbide-based electrocatalysts in the literature (Table 5); (g) Stepwise chronopotentiometry profiles of Co/W₂TiC₂-700 in 1 M KOH from 10 to 50 mA cm⁻² as tests of stability; (h) High current density LSV polarization curves of Co/W₂TiC₂-700 catalyst compared with commercial 40% Pt/C in N₂ saturated 1 M KOH; (i) Continuous chronopotentiometry stability test of Co/W₂TiC₂-700 catalyst at −10 mA cm⁻² (without iR compensation) in 1 M KOH with the half-cell electrolyzer.

FIG. 5. (a) DFT-calculated adsorption free energies of an isolated H* (G_{H*}, eV) at different binding sites on the Co nanoparticle/W₂TiC₂ model; (b) DFT-calculated adsorption free energies of an isolated H* (G_{H*}, eV) vs. d-band center of interfacial W atom (eV) relative to respective fermi levels. The inset image in (b) shows a (3×3) periodic slab of W₂TiC₂ MXene used for modeling systems with 0-4 Co atoms at W₂TiC₂. Notation: isolated Co (Coᵢₛₒ), Co dimer (Co_{di}), Co trimer (Coₜᵣᵢ), Co tetramer (Coₜₑₜ), and Co nanoparticle (Co_{NP}).

FIG. 6A-F. Flow cell electrolyzer tests. (a) Schematic diagram of two-electrode flow cell electrolyzer for high current density HER tests; (b) High current LSV polarization curves of Co/W₂TiC₂-700 and commercial Pt/C with same loading mass (0.5 mg/cm²) paired with Ni foam in the 2×2 cm² flow cell electrolyzer in 1 M KOH. (c) Comparison of the cell potential for Ni Foam∥Commercial Pt/C and Ni Foam∥Co/W₂TiC₂-700 at 50-400 mA cm⁻². The error bars are standard deviations of the cell voltage data. (d) Chronopotentiometry profiles of Co/W₂TiC₂-700 at 50-400 mA cm⁻² in 1 M KOH compared with Pt/C; (e) Comparison of hydrogen production and Faradaic efficiency on Co/W₂TiC₂-700 and Pt/C in consistent 15 h operations at 50-400 mA cm⁻²; (f) Continuous chronopotentiometry stability test of Co/W₂TiC₂-700 catalyst at 4 A cm⁻² (without iR compensation) in 1 M KOH with the flow cell electrolyzer.

FIG. 7. SEM images of (a) Co/W₂TiC₂-600 and (b) Co/W₂TiC₂-700.

FIG. 8. STEM images of (a) Co/W₂TiC₂-600 and (b) Co/W₂TiC₂-700.

FIG. 9. High-resolution TEM image of Co/W₂TiC₂-500 showing lattice fringes corresponding to cobalt on the MXene surface.

FIG. 10. XPS survey spectra of W₂TiC₂Tₓ and Co/W₂TiC₂ annealed at 500, 600, and 700° C.

FIG. 11. Linear sweep voltammetry (LSV) curves of the synthesized Co/W₂TiC₂-700 catalyst in: (a) 1 M KOH, 1 M PBS, 0.5 M H₂SO₄; (b) PBS solutions with varying concentrations (0.1, 0.25, 0.5, 0.75, and 1 M). PBS refers to phosphate buffered saline.

FIG. 12. Cyclic voltammetry (CV) curves of (a) W₂TiC₂Tₓ and (c) Co/WC at different scan rates in a non-Faradaic region, and electrochemical double-layer capacitance calculated from charging current density differences against scan rates plots, shown in the linear fitting plots.

FIG. 13. CV curves of (a) Co/W₂TiC₂-700, (b) Co/W₂TiC₂-600, and (c) Co/W₂TiC₂-500, and electrochemical double-layer capacitance calculated from charging current density differences against scan rates plots, shown in the (d) linear fitting plots.

FIG. 14. (a) Formation energy of Co cluster (Eco, eV) for different configurations of Co on W₂TiC₂ at respective H* coverages (ML), (b) Cumulative adsorption free energy of nH* (G_{nH*}, eV) on different W₂TiC₂ surfaces at respective H* coverages (ML). All the data points for a given surface coverage of H* are joined by a solid line for ease of visualization of the overall trend in both the figures.

FIG. 15. Comparison of the cell voltage for IrO2∥Commercial Pt/C and IrO₂∥ Co/W₂TiC₂-700 at 50 to 400 mA cm⁻². The error bars are standard deviations of the cell voltage data.

FIG. 16. Comparison of hydrogen production rates and hydrogen Faradaic efficiencies of Co/W₂TiC₂-700 and Pt/C at current densities ranging from 50 to 400 mA cm⁻² in 1M KOH at 60° C.

### DETAILED DESCRIPTION

Electrocatalysis plays a central role in enabling large-scale green hydrogen production from water electrolysis. It is important to develop efficient, durable, and earth-abundant catalysts that operate at industrially relevant realistic operating conditions. Here, we reported a new type of 2D metal carbide (MXene)—tungsten titanium carbide (W₂TiC₂Tₓ, where T stands for surface termination groups) synthesized for the first time from a novel MAX precursor route. By loading cobalt (Co) onto the surface of W₂TiC₂Tₓ and rationally designing of the local atomic and interface configurations, we developed an effective and highly stable catalyst for alkaline hydrogen evolution reaction (HER). The optimized Co/W₂TiC₂ catalyst exhibits small overpotentials of 63 mV and 191 mV at 10 and 100 mA cm⁻², respectively, and achieves outstanding long-term operational durability, maintaining stable hydrogen production at 4000 mA cm⁻² for over 1000 hours.

In a flow-cell MEA electrolyzer, it delivers near-unity hydrogen Faradaic efficiency over a wide current range (50-400 mA cm⁻²), while requiring significantly lower cell voltages than commercial Pt/C under same conditions. Comprehensive structural analysis with in-situ X-ray photoelectron spectroscopy (XPS), X-ray absorption near edge structure (XANES), and extended X-ray absorption fine structure spectroscopy (EXAFS) reveal that thermal modulation induces a transformation of Co from isolated atoms and large nanoparticles (NPs) into uniform sub-nanometer particles anchored on the tungsten outer layers. Density functional theory (DFT) calculations reveal that the HER activity was sensitive to the coordination environment of Co on W₂TiC₂ and identify Co—W interfacial sites as the primary active centers. This work demonstrates a structurally well defined, non-precious HER catalyst capable of operating under harsh industrial conditions. It sheds light on structure design and utilization of metal-support interaction (MSI) in MXene-supported metal catalysts for the efficient electrochemical water splitting.

Additional information and data that can be used with aspects of the invention described herein can be found in the following publication: doi.org/10.21203/rs.3.rs-4427524/v1 and its Supporting Information, which are incorporated herein by reference.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

The recitation of a), b), c), . . . or i), ii), iii), or the like in a list of components or steps do not confer any particular order unless explicitly stated.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation or limitations which is not specifically disclosed herein.

This disclosure provides methods of making the compounds and compositions of the invention. The compounds and compositions can be prepared by any of the applicable techniques described herein, optionally in combination with standard techniques of organic synthesis. Many techniques such as etherification and esterification are well known in the art.

As used herein, the term “substituted” or “substituent” is intended to indicate that one or more (for example, in various embodiments, 1-10; in other embodiments, 1-6; in some embodiments 1, 2, 3, 4, or 5; in certain embodiments, 1, 2, or 3; and in other embodiments, 1 or 2) hydrogens on the group indicated in the expression using “substituted” (or “substituent”) is replaced with a selection from the indicated group(s), or with a suitable group known to those of skill in the art, provided that the indicated atom's normal valency is not exceeded, and that the substitution results in a stable compound.

The term “early transition metal(s)” refers to groups 3, 4, and 5 of the periodic table; the term “middle transition metal(s)” refers to groups 6, 7, and 8 of the periodic table, and the term “late transition metal(s)” refers to groups 9, 10, and 11 of the periodic table.

### Embodiments of the Technology

1. An annealed catalyst comprising a delaminated MXene support of Formula I:

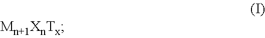

wherein
   M is a combination of a middle transition metal and an early transition metal;
   X is a non-metal wherein the non-metal is carbon or nitrogen;
   Tₓ is a surface functional group wherein x is 0-10; and
   n is 2 or 3; and
late transition metal nanoparticles having a particle size of about 0.5 nm to about 2.0 nm, wherein less than 5 weight percent of the late transition metal nanoparticles are uniformly distributed onto a basal plane of the MXene support based on the weight of the catalyst;
wherein metal support interactions at an interface of atoms of the late transition metal nanoparticles and atoms of the middle transition metal are present in the catalyst.
   2. The annealed catalyst of embodiment 1, wherein about 3.5 weight percent to about 4.5 weight percent of the late transition metal nanoparticles are uniformly distributed onto the MXene support.
   3. The annealed catalyst of embodiment 1 or 2, wherein the late transition metal nanoparticles have a particle size of about 0.8 nm to about 1.0 nm.
   4. The annealed catalyst of any one of embodiments 1-3, wherein the late transition metal nanoparticles are more than about 50% metallic or less than about 50% oxidized.
   5. The annealed catalyst of any one of embodiments 1-4, wherein the late transition metal nanoparticles are about 100% metallic.
   6. The annealed catalyst of any one of embodiments 1-5, wherein the annealed catalyst was annealed at about 450° C. to about 750° C.
   7. The annealed catalyst of any one of embodiments 1-6, wherein the annealed catalyst was annealed at about 700° C.
   8. The annealed catalyst of any one of embodiments 1-7, wherein the metal support interactions are d-band metal support interactions.
   9. The annealed catalyst of any one of embodiments 1-8, wherein the late transition metal nanoparticles consist of one to five layers of its atoms positioned on the basal plane of the MXene support,
   10. The annealed catalyst of any one of embodiments 1-9, wherein the middle transition metal is tungsten; or
in some embodiments, the early transition metal is titanium; or
in some embodiments, the middle transition metal is tungsten; and the early transition metal is titanium.
   11. The annealed catalyst of any one of embodiments 1-10, wherein X is carbon and n is 2; or
in some embodiments, X is carbon, n is 2, and x is 0.
   12. The annealed catalyst of any one of embodiments 1-11, wherein the delaminated MXene support of Formula I is Formula II:

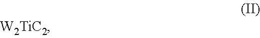

wherein the delaminated MXene support comprises a layer of tungsten atoms, a layer of carbon atoms, and a layer of titanium atoms that alternate in the sequence W—C—Ti—C to form a layer of titanium atoms in-between two layers of carbon atoms that are sandwiched together between two layers of tungsten atoms.

In various embodiments, the two layers of carbon atoms are sandwiched between three layers of metal atoms to form layers in the MXene support comprising W—C—Ti—C—W.

In some embodiments, the delaminated MXene support comprises two layers of tungsten atoms, a layer of carbon atoms, and a layer of titanium atoms that alternate in the sequence W—C—Ti—C—W to form a layer of titanium atoms in-between two layers of carbon atoms that are sandwiched together between two layers of tungsten atoms.

13. The annealed catalyst of any one of embodiments 1-12, wherein the late transition metal nanoparticles are cobalt metal nanoparticles.
14. A delaminated MXene support of Formula I:

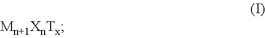

wherein
   M is a combination of a middle transition metal and an early transition metal;
   X is a non-metal wherein the non-metal is carbon or nitrogen;
   Tₓ is a surface functional group wherein x is 0-10; and
   n is 2 or 3.
      15. The delaminated MXene support of embodiment 14, wherein the delaminated MXene support

### is Formula II:

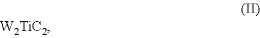

wherein the delaminated MXene support comprises a layer of tungsten atoms, a layer of carbon atoms, and a layer of titanium atoms that alternate in the sequence W—C—Ti—C to form a layer of titanium atoms in-between two layers of carbon atoms that are sandwiched together between two layers of tungsten atoms.

In various embodiments, the two layers of carbon atoms are sandwiched between three layers of metal atoms to form layers in the MXene support comprising W—C—Ti—C—W.

In some embodiments, the delaminated MXene support comprises two layers of tungsten atoms, a layer of carbon atoms, and a layer of titanium atoms that alternate in the sequence W—C—Ti—C—W to form a layer of titanium atoms in-between two layers of carbon atoms that are sandwiched together between two layers of tungsten atoms.

16. A method for an electrocatalytic hydrogen evolution reaction comprising:
a) contacting an alkaline aqueous electrolyte with a catalyst loaded onto a cathode, wherein the catalyst was annealed at about 700° C. and comprises:
   i) a delaminated MXene support of Formula II:

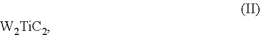

wherein the delaminated MXene support comprises a layer of tungsten atoms, a layer of carbon atoms, and a layer of titanium atoms that alternate in the sequence W—C—Ti—C to form a layer of titanium atoms in-between two layers of carbon atoms that are sandwiched together between two layers of tungsten atoms, such that the two layers of carbon atoms are sandwiched between three layers of metal atoms to form a group of layers in the MXene support comprising W—C—Ti—C—W.
   ii) cobalt metal nanoparticles having a size of about 0.8 nm to about 1.0 nm, wherein about 3.5 weight percent to about 4.5 weight percent of the cobalt metal nanoparticles are uniformly distributed onto a basal plane of the MXene support based on the weight of the catalyst; and
b) applying a current to the cathode;
   wherein an electrocatalytic reaction occurs at the cathode to form the evolution of hydrogen gas.

In some embodiments of step i), the delaminated MXene support comprises two layers of tungsten atoms, a layer of carbon atoms, and a layer of titanium atoms that alternate in the sequence W—C—Ti—C—W to form a layer of titanium atoms in-between two layers of carbon atoms that are sandwiched together between two layers of tungsten atoms, such that the two layers of carbon atoms are sandwiched between three layers of metal atoms to form a group of layers in the MXene support comprising W—C—Ti—C—W.

17. The method of embodiment 16, wherein d-band metal support interactions at an interface of atoms of the cobalt metal nanoparticles and atoms of the tungsten metal are present in the catalyst, wherein the interface is an active site for catalytic formation of hydrogen gas.
18. The method of embodiment 16 or 17, wherein the cobalt metal nanoparticles are about 100% cobalt(0) metal nanoparticles.
19. The method of any one of embodiments 16-18, wherein the cathode is loaded with about 10 mg/cm² to about 15 mg/cm² of the catalyst.
20. The method of any one of embodiments 16-19, wherein the cathode is loaded with about 0.4 mg/cm² to about 0.6 mg/cm² of the cobalt metal nanoparticles.

### Results and Discussion

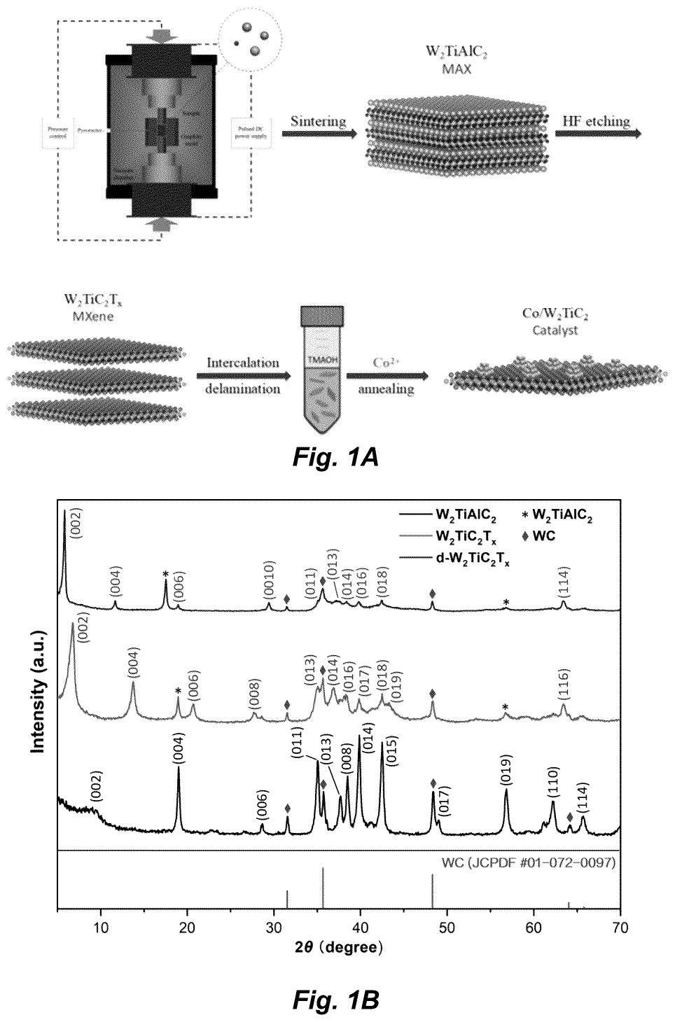

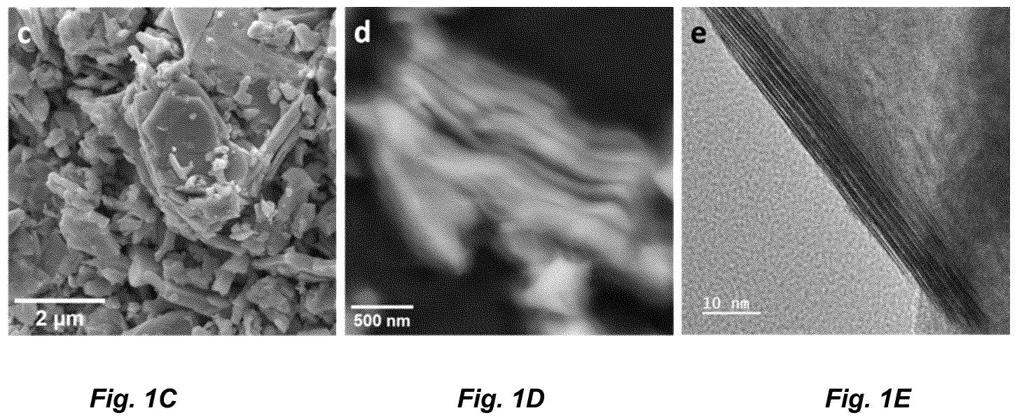

W₂TiC₂Tₓ MXene and Co/W₂TiC₂ catalysts. The synthesis procedure of W₂TiC₂Tₓ MXene is shown in FIG. 1. The bulk W₂TiAlC₂ MAX precursor was first prepared by spark plasma sintering of commercial powders. Two dimensional W₂TiC₂Tₓ was then obtained by selective etching of the aluminum layers with hydrofluoric acid (HF). Tetramethylammonium hydroxide (TMAOH) was used, followed by sonication to exfoliate the MXene into thinner layers. The X-ray diffraction (XRD) pattern of W₂TiAlC₂ showed the characteristic peak of (004) plane at 2θ=19° (FIG. 1b), and the peak positions exhibited good agreement with the pattern simulated in VESTA by importing the lattice parameters derived by the 2θ values of the (110), (101), and (004) peaks of the experimental results. The complete phase assignment for each diffraction peak is provided in FIG. 1b.

XRD refinement was conducted by GSAS software and the alignments of main peaks including (006), (103), (104), (008) and (106) were achieved, confirming the expected W₂TiAlC₂ composition and structure. The (002) diffraction peak showed up in a lower angle (2θ=6.8°) after the HF etching, indicating a larger c lattice parameter of W₂TiC₂Tₓ due to the removal of aluminum layers. After exfoliation, the (002) plane peak shifted further to 2θ=5.85°, consistent with the expansion along the [001] direction. The experimental XRD also aligned with VESTA simulated XRD for W₂TiC₂Tₓ, showing the c lattice parameter increasing from to 1.873 nm to 3.009 nm. Scanning electron microscopy (SEM) image of W₂TiC₂Tₓ MXene showed the typical accordion-like morphology of MXene with stacked nanosheets (FIG. 1d). More magnified observation through transmission electron microscopy (TEM) of a thin W₂TiC₂Tₓ piece with curled edge revealed that the nanosheets were composed of few layers of MXenes, as shown in the side view (FIG. 1e). Lateral structures of alternating atom layers of various contrast were observed from the sidelined pieces, validating the M₃C₂ structure of W₂TiC₂Tₓ.

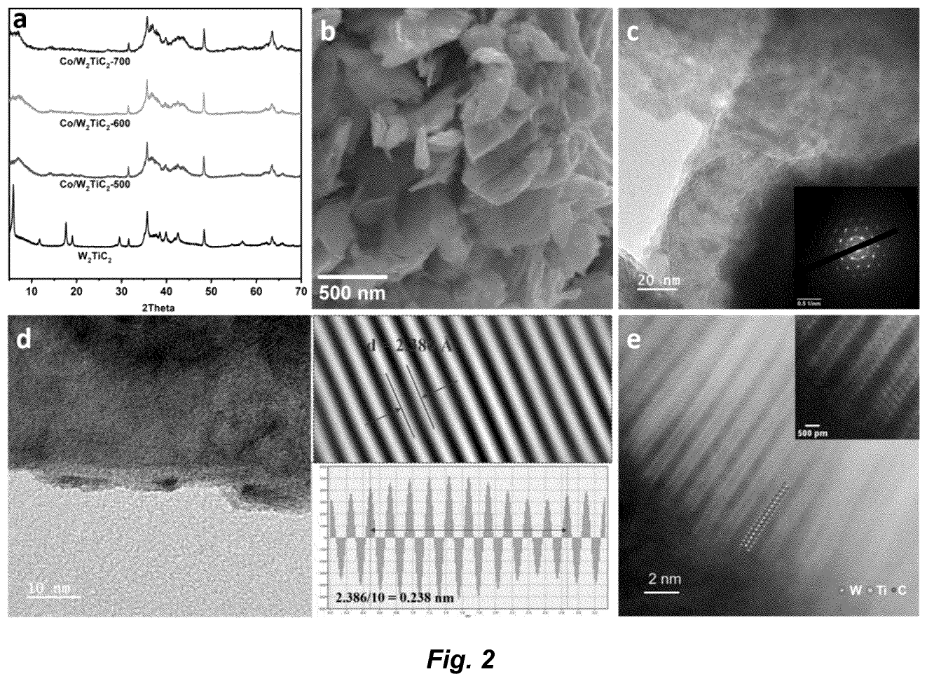

Co was then loaded on the W₂TiC₂Tₓ MXenes by incipient wetness impregnation of cobalt chloride precursor, followed by reduction under H₂/N₂ atmosphere at different temperatures, denoted as Co/W₂TiC₂-n (n is applied temperature in degree Celsius, n=500, 600, 700). The X-ray diffractograms of the Co/W₂TiC₂-500, 600 and 700 catalysts (FIG. 2a) exhibited broad small Co peaks at around 2θ=440 region, suggesting the existence of metallic Co. The broadening of the peaks resulted from small nanoparticle sizes, which was confirmed later by the Extended X-ray absorption fine structure spectroscopy (EXAFS) fitting results. The decrease in the intensity of the MXene peaks and slight shift to higher 2θ of the (002) peak with increasing temperature suggested a slight decrease in the inter-flake spacing after the introduction of Co. The SEM image in FIG. 2b showed that the thin layer morphology of the MXene was maintained after the Co loading with no large Co grains being observed, indicating the uniform distribution of Co on the MXene surface. The TEM image of Co/W₂TiC₂ in FIG. 2d showed the MXene layers, with a consistent d spacing measured as 0.24 nm for the (0110) lattice planes.

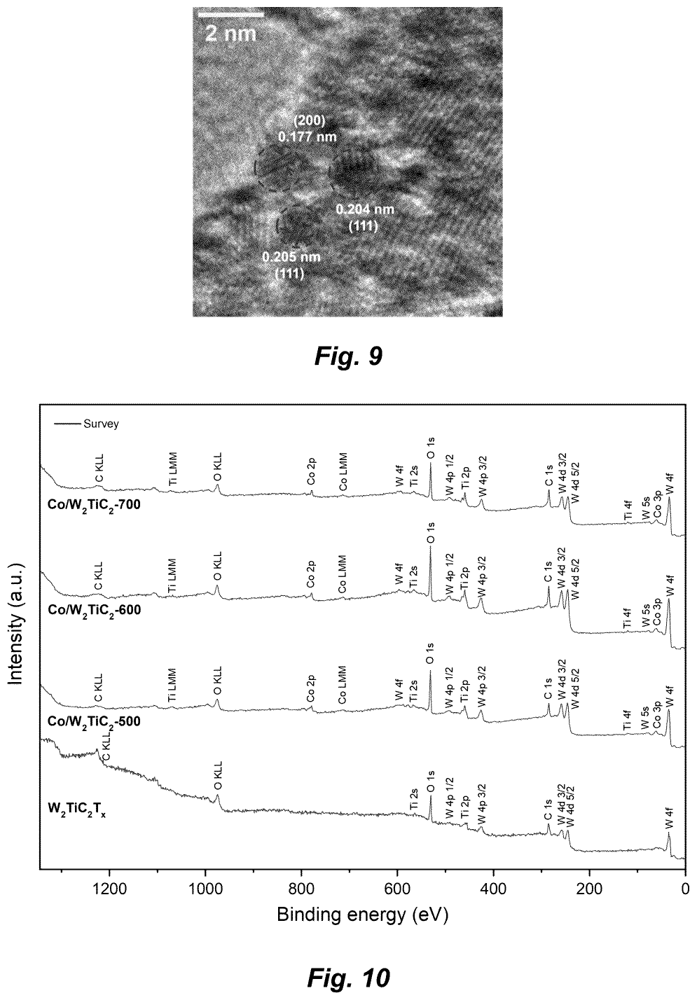

The selected area electron diffraction (SAED) pattern further confirmed the basal plane hexagonal symmetry structure (FIG. 2c). Owing to the high extra-nuclear electron density of tungsten element, Co imaging was hindered by W₂TiC₂ under TEM and cannot be observed clearly except by mass thickness contrast on very thin areas of sample edge. In FIG. 2d, small dark patches were found at the edge of a MXene flake. Similar dark regions of 1-2 nm size can be observed on very thin regions of the Co/W₂TiC₂-500 sample (FIG. 9). Lattice fringes distinguished from the lattice of W₂TiC₂ were marked and measured to be 0.204 nm and 0.177 nm, matching the (111) and (200) planes of face-centered-cubic Co respectively. The grain boundaries were not sufficiently distinct owing to the same reason mentioned above, necessitating the employment of additional characterization techniques to validate the presence of Co particles or patches. The aforementioned small dark regions were not observed in Co/W₂TiC₂-600 and Co/W₂TiC₂-700 samples, which could potentially be attributed to the further reduced size of Co in these catalysts.

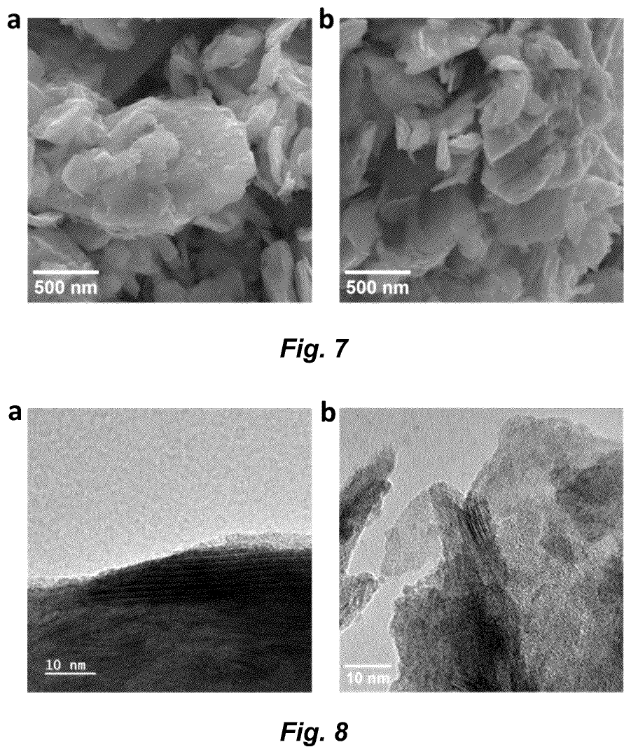

High-angle annular dark-field scanning transmission electron microscopy (HAADF-STEM) with energy dispersive X-ray spectroscopy (EDS) was employed to characterize the Co/W₂TiC₂ catalysts (FIG. 2e). The EDS mappings show the signals of W, Ti and Co uniformly distributed through the sample without obvious phase segregation. The two-dimensional structure of W₂TiC₂ featuring orderly arranged metal layers was clearly presented from the side view STEM image (FIG. 2e). SEM and STEM images of Co/W₂TiC₂ treated at 500° C. and 600° C. were also displayed in FIG. 7 and FIG. 8. As the contrast in STEM images was directly related to the atomic number of the elements, the brighter outermost layers were identified as W, while the inner darker layers were attributed as Ti. The ordered three metal layers agreed well with the simulated W₂TiC₂ structure.

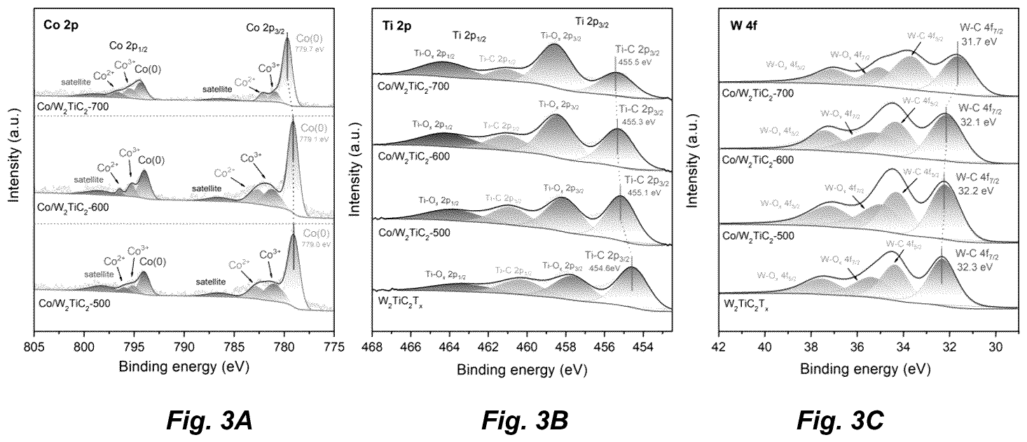

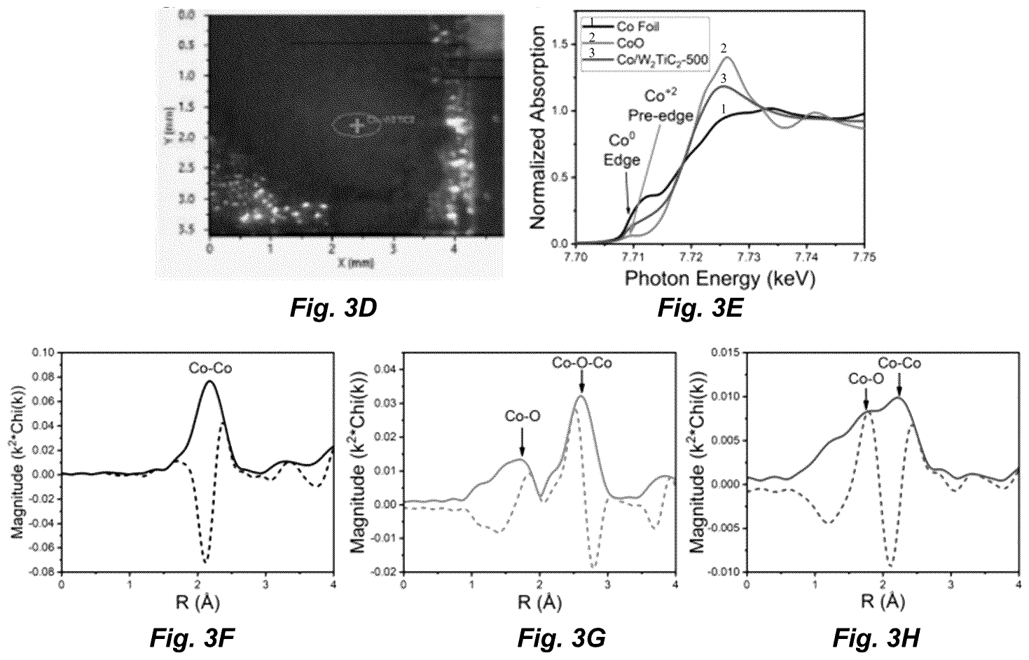

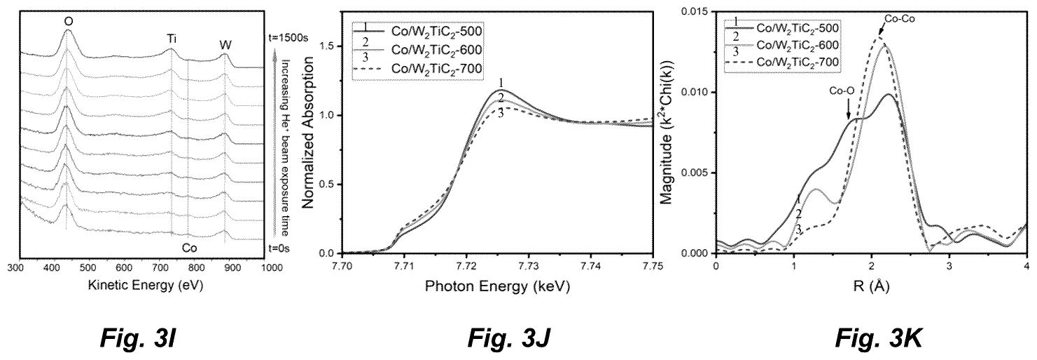

The structure of Co/W₂TiC₂ and the impact of reduction temperature on the metal-support interaction were further investigated by X-ray photoelectron spectroscopy (XPS) and ion scattering spectroscopy (ISS). The in-situ XPS survey and high-resolution spectra were shown in FIG. 10 and FIG. 3a-c. The survey spectra confirmed the presence of W, Ti, C, O, and Co. The W 4f spectrum displayed characteristic peaks at around 32.3 eV, corresponding to W in MXene environment (W—C). Interestingly, the binding energy of W 4f peak decreases from 32.3 eV of W₂TiC₂Tₓ to 32.2 eV, 32.1 eV, and 31.7 eV for Co/W₂TiC₂-500, 600, and 700 samples, respectively.

The Co 2p spectrum reveals that metallic Co is the predominant species, accompanied with minor features attributed to Co—Oₓ, and a pair of shake-up satellite of Co—Oₓ 2p_{3/2} and 2p_{1/2}, indicating the presence of metallic Co with slightly oxidized surface. The Co peaks shifted slightly to higher binding energy from 779.0 eV to 779.1 eV and 779.7 eV (Co/W₂TiC₂-500, 600, and 700, respectively). Combining the changes in W 4f and Co 2p binding energy, it suggests more electrons drawn from Co towards W as the reduction temperature increased, indicating an enhanced interaction between Co and surface W. Same positive binding energy shift of Ti with the increasing temperature further validated the regulation of reduction condition on the electronic structure and interaction.

Ion scattering spectroscopy (ISS—XPS) was employed to characterize the depth-dependent compositional profile of this surface metal loaded two-dimensional catalyst. FIG. 3d showed live optical view of the Co/W₂TiC₂-700 sample, and FIG. 3i displayed the continuous scattered ions intensity profile change on the Co/W₂TiC₂-700 catalyst with the helium (He⁺) exposure time. At t=0s, only Co and W peaks were observed with a barely noticeable Ti peak, indicating the position of Co and W on the top surface of Co/W₂TiC₂. With the increasing exposure time, the He⁺ beam gradually etched the surface and the Ti peak became stronger, while the peak of Co gradually vanished. As ISS provided elemental information from the top monolayer of the surface, this depth profile further confirmed the presence of Co on the surface as well as the Ti sandwiched between W atom layers in the W₂TiC₂Tₓ MXene.

Co structure transformation between single sites and nanoparticles on W₂TiC₂Tₓ. XANES and EXAFS studies were conducted to gain more accurate information about the structures and coordination environments of Co under different reducing temperatures. The Co K-edge XANES energy was the electromagnetic transition from is electron to the 4p empty orbital. The XANES energy is determined from the first inflection point of the leading edge. For 3d transition metals, a pre-edge peak is often observed, which is due to the is to 3d forbidden transition. The oxidation state could be determined by pre-edge peak and edge energy. Co foil (Co⁰) has no pre-edge peak and XANES energy is 7.7090 keV, while CoO reference (Co²⁺) has a pre-edge peak at 7.7084 keV and XANES energy at 7.7166 keV (FIG. 3e). The edge energy of all our Co/W₂TiC₂ samples were very similar and nearly identical to that of Co⁰, indicating the metallic nature of Co (Table 1). The similarity in the shapes of the XANES spectra indicated that the local structures on the catalysts are also similar (FIG. 3e).

TABLE 1
Quantitative information of the XANES data and EXAFS fits.

| | Pre-edge Energy | XANES Energy | | | | δ² | |
|---|---|---|---|---|---|---|---|
| Samples | keV | keV | Scatter | CN | R, Å | (×10³) | E₀, eV |
| Co Foil (Co⁰ ref) | — | 7.709 | Co—Co | 12 | 2.49 | — | — |
| CoO (Co²⁺ ref) | 7.7084 | 7.7166 | Co—O | 6 | 2.13 | — | — |
| Co/W₂TiC₂-500 | — | 7.7087 | Co—Co | 2.8 | 2.48 | 8.0 | −4.4 |
| | | | Co—O | 2.1 | 1.97 | 6.0 | −2.8 |
| Co/W₂TiC₂-600 | | 7.7087 | Co—Co | 3.3 | 2.49 | 8.0 | −4.8 |
| | | | Co—O | 1.1 | 1.96 | 6.0 | 1.1 |
| Co/W₂TiC₂-700 | | 7.7087 | Co—Co | 3.8 | 2.47 | 10.0 | −5.0 |
| | | | Co—O | — | — | — | — |

Fitting the EXAFS spectra gave information about the coordination numbers (CNs) and bond distance, as summarized in Table 1. The Co K-edge EXAFS spectra for Co foil and CoO reference were shown in FIG. 3f and FIG. 3g. EXAFS results suggested the Co was highly metallic with small amounts of oxidized Co. No alloy formation with W was found by fitting the Fourier transform of the first shell (FIG. 3j). The NPs sizes were estimated based on their CN (J. Catal. 2006, 240, 222-234) and the results suggested the major phase was extremely small Co nanoparticles (NPs). The further fittings of all Co/W₂TiC₂ samples showed Co—O bond distance of 1.97 Å.

Unlike the typical Co—O bond distance of 2.13 Å in small CoO clusters reference, the much shorter Co—O bond distance observed in our Co/W₂TiC₂ samples was very similar to previously reported single site Co structure which had Co⁺² with 4 Co—N(C) at 1.95 Å (Small 2021, 17, 2006477). Fitting of the Co/W₂TiC₂-500 showed a Co—O CN of 2.1, indicating about 50% of the Co existing as single site Co⁺² (isolated Co, Coᵢₛₒ) on the MXene surface and 50% existing as metallic Co NPs. With the fraction of oxidized Co equal to fit CN/CN of the pure species, metallic Co with Co—Co fitted CN of 2.8 should have a true CN of 5.6 and metallic NPs with this CN should have a size of about 1.5 nm. As the reduction temperature increased, the proportion of oxidized Co decreased, resulting in nearly all metallic Co for Co/W₂TiC₂-700. For Co/W₂TiC₂-600 sample, the Co—O CN was about 1, indicating 25% single site Co⁺² and the true Co—Co CN for the rest 75% metallic Co being 4.4 with NP sized at about 1.0 nm. Co/W₂TiC₂-700 had a Co—Co CN of 3.8, corresponding to the NPs about 0.9 nm. The summary of percentage of single sites, nanoparticles and nanoparticle sizes were listed in Table 2.

TABLE 2
Summary of distribution of Co on the different catalysts.

| Catalyst | Single sites | NPs | NPs true CN | NPs size |
|---|---|---|---|---|
| Co/W₂TiC₂-700 | — | 100% | 3.8 | 0.9 nm |
| Co/W₂TiC₂-600 | ~25% | ~75% | 4.4 | 1.0 nm |
| Co/W₂TiC₂-500 | ~50% | ~50% | 5.6 | 1.5 nm |

The higher shell Co—(O)—Co peak of Co-oxide nanoparticles was not detectable due to an overlap with the Co—Co scattering path. Subtraction of the Co—Co scattering indicated a very small amount Co—(O)—Co consistent few CoO clusters. Combined with the bond distance, the results suggested the Co on W₂TiC₂ was highly metallic with certain portion existing as single site Co⁺² with little surface oxidation. Unlike the rapid oxidation of normal small metallic nanoparticles obtained by other synthesis methods, the tiny Co NPs on W₂TiC₂ were highly resistive to oxidation even when exposed to air. This further confirmed the strong metal-support interaction between Co and W₂TiC₂, i.e., the electrons being drawn from Co to W₂TiC₂ making Co electronically “more positive” and less vulnerable to oxidation. As the reduction temperature increased from 500° C. to 700° C., the Co structure progressively homogenized, changing from a mixture of single sites and metallic NPs (˜1.5 nm at 500° C.) to smaller metallic NPs (˜1 nm at 600° C.), and ultimately forming well-dispersed sub-1 nm Co NPs (˜0.9 nm at 700° C.).

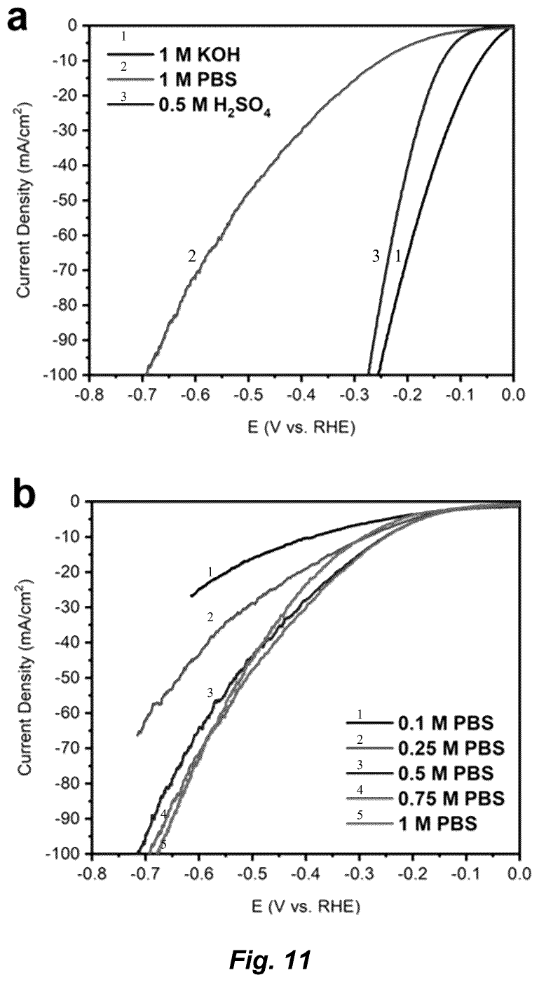

Electrochemical HER evaluation of Co/W₂TiC₂ catalysts. To explore the catalytic activity of the Co/W₂TiC₂ catalysts, the HER performance was evaluated in an H-cell using the three-electrode system. The HER performance of the same Co/W₂TiC₂ catalyst (i.e., Co/W₂TiC₂-700 sample) in acidic, neutral, and alkaline media were first compared. As shown in FIG. 11, the current density in 1 M KOH and 0.5 M H₂SO₄ significantly exceeds that in 1 M PBS, suggesting the catalyst was more suitable for catalyzing hydrogen evolution in alkaline and acidic environments. Under acidic condition, the HER performance gave the smallest overpotential of 134 mV at 10 mA cm⁻² with Tafel slope of 72.7 mV dec⁻¹. In 1 M KOH, Co/W₂TiC₂-700 exhibited the most favorable HER performance, as evidenced by the lowest overpotential and most rapid increase in current density with applied potential in the polarization curve. Given the current industrial demand for alkaline water electrolysis catalysts and the observed best performance in 1 M KOH electrolyte of the Co/W₂TiC₂-700 sample, a detailed analysis was conducted to determine the electrocatalytic performance of all the Co/W₂TiC₂ catalysts under alkaline conditions.

To evaluate the contribution of Co metal and W₂TiC₂ MXene to the catalytic performances, control experiments were conducted using pure W₂TiC₂Tₓ MXene and Co/WC (commercial tungsten carbide) reduced at 700° C. The metal loading on the catalysts was confirmed by inductively coupled plasma optical emission spectrometry (ICP-OES), the Co contents in Co/W₂TiC₂-500, 600, and 700 were determined to be 4.1%, 4.0%, and 4.3%, respectively, with an approximate average atomic ratio of 4.13%, confirming the total Co amounts in the catalysts are close with no obvious variation across all the three reduction temperatures (Table 3).

TABLE 3
ICP-OES elemental analysis of the Co/W₂TiC₂ samples.

| Catalysts | Co Weight % | Averaged Co Weight % |
|---|---|---|
| Co/W₂TiC₂-700 | 4.27% | 4.3% |
| | 4.36% | |
| | 4.28% | |
| Co/W₂TiC₂-600 | 4.04% | 4.0% |
| | 3.89% | |
| | 3.95% | |
| Co/W₂TiC₂-500 | 4.10% | 4.1% |
| | 4.15% | |
| | 4.01% | |

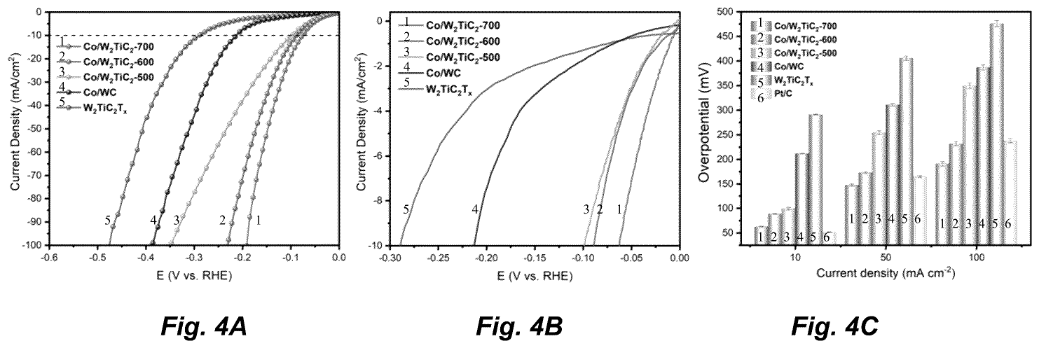

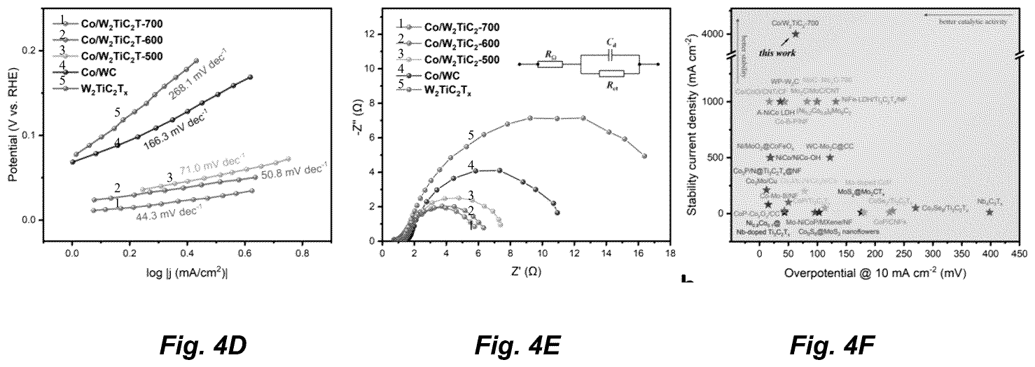

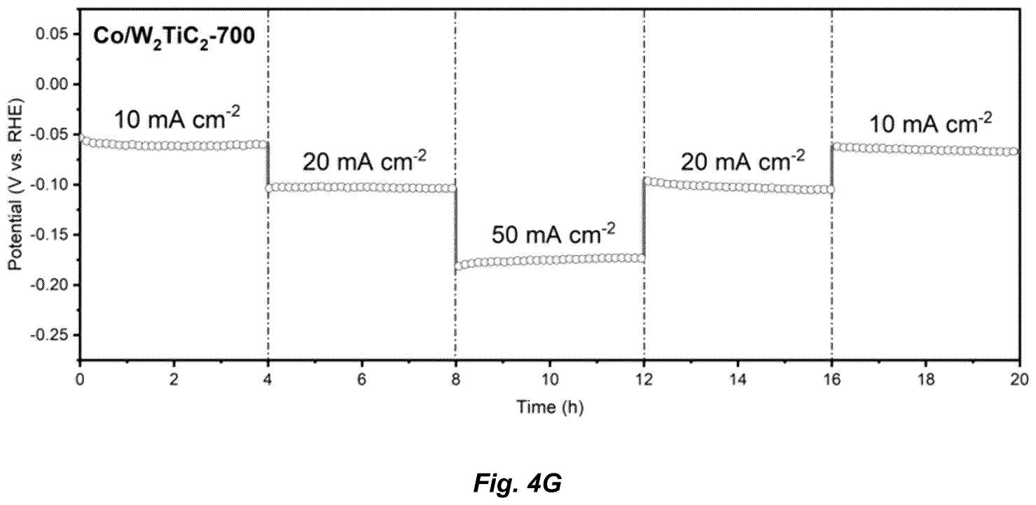

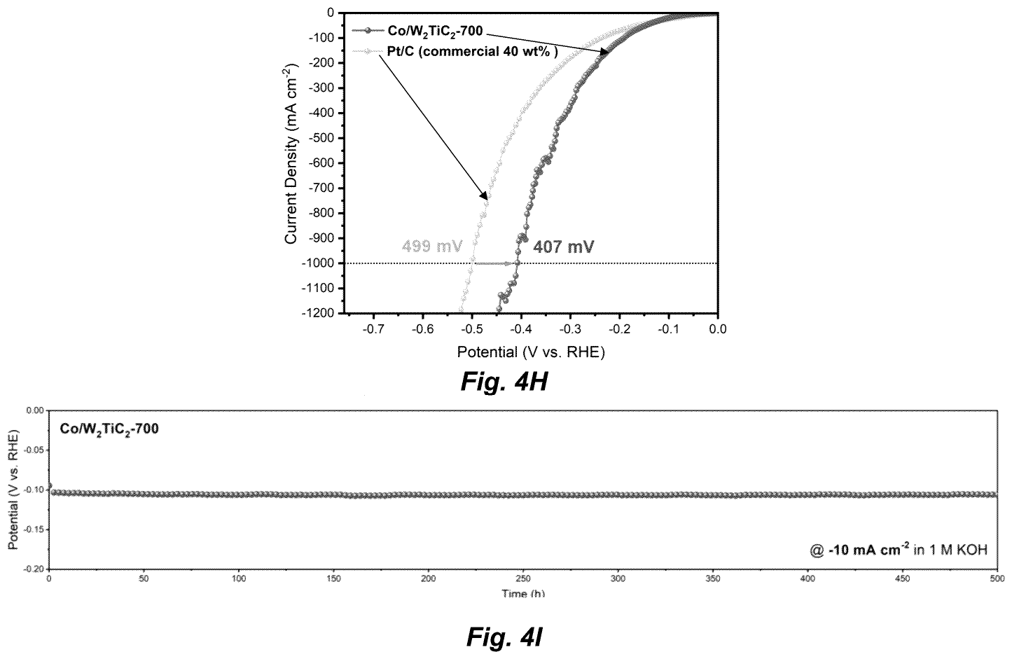

To provide a fair comparison, uniform Co and overall catalyst loading mass were applied on each electrode, as detailed in Table 4. All the Co-containing catalysts (FIG. 4a and FIG. 4b) exhibited higher HER activities compared to the pristine W₂TiC₂Tₓ, underscoring the critical role of Co in the HER activity. Furthermore, all three Co/W₂TiC₂ catalysts showed superior activity of below 100 mV overpotential compared to Co/WC, which exhibited a 212 mV overpotential at current density of 10 mA cm⁻²(η@10 mA cm⁻²). This performance difference could be attributed to the two-dimensional nature of W₂TiC₂, providing more active sites than the bulk WC. Noticeably, Co/W₂TiC₂-700 stands out as the best catalyst, with the smallest overpotential of 63 mV at 10 mA cm⁻², followed by Co/W₂TiC₂-600 (89 mV at 10 mA cm⁻²) and Co/W₂TiC₂-500 (99 mV at 10 mA cm⁻²).

The relatively subdued HER performance of Co/W₂TiC₂-500 among the three catalysts can be attributed to the lower fraction and slightly larger metallic NP size among all the three Co/W₂TiC₂ samples, as explained in the following theoretical modeling section. Notably, the advantage of small overpotential became even more pronounced at higher current densities. Co/W₂TiC₂-700 showed overpotential of 192 mV@100 mA cm⁻², outperforming commercial 40% Pt/C which had an overpotential 238 mV@100 mA cm⁻² by 46 mV (FIG. 4c). At higher current density, Co/W₂TiC₂-700 continued to exhibit excellent low overpotentials as 330 mV@500 mA cm⁻² and 407 mV@1000 mA cm⁻² (FIG. 4h), highlighting its great potential in industrial-level high current density alkaline hydrogen production.

TABLE 4
The Co and total loading mass of different
catalysts on the electrodes.

| Catalysts | Loading of catalyst | Loading of Co |
|---|---|---|
| Co/W₂TiC₂-700 | 12.3 mg/cm² | 0.49 mg/cm² |
| Co/W₂TiC₂-600 | 12.9 mg/cm² | 0.52 mg/cm² |
| Co/W₂TiC₂-500 | 12.8 mg/cm² | 0.51 mg/cm² |
| Co/WC | 14.7 mg/cm² | 0.59 mg/cm² |
| W₂TiC₂ | 12.5 mg/cm² | — |

The Tafel slopes (FIG. 4d) of Co/W₂TiC₂-700, Co/W₂TiC₂-600, Co/W₂TiC₂-500, Co/WC and pristine W₂TiC₂Tₓ were 44.3, 50.8, 71.0, 166.3, and 268.0 mV dec⁻¹, respectively. The smallest slope of Co/W₂TiC₂-700 showed rapid change of current density with slight increases in applied voltage, indicating the fastest reaction kinetics. The small Tafel slope of Co/W₂TiC₂-700 also outperformed most of reported non-noble metal catalysts within the realm of alkaline HER, as compared in Table 5. The electrochemical impedance spectra (EIS) were collected to study the charge transfer efficiency (FIG. 4e). Nyquist plots showed close solution resistance (Rₛ) values for all the tests and distinguished charge transfer resistance (R_{ct}) of the catalysts, suggesting similar electrolyte solution environment. Co/W₂TiC₂-700 and Co/W₂TiC₂-600 exhibited small semi-circles of the curve, indicating faster charge transfer property. The reduced charge transfer resistance of the Co/W₂TiC₂ catalysts in comparison to Co/WC and pristine W₂TiC₂ demonstrated the optimized electron transfer facilitated by the synergistic metal-support interaction between Co and W₂TiC₂, which agreed with the diminished surface oxidation at higher annealing temperature as observed from XPS and EXAFS analyses.

TABLE 5
Comparison of alkaline HER performance reported for cobalt and transition metal carbide based non-noble metal catalysts.

| | η @ 10 | Tafel slope | η @ 100 | η @ 500 | η @ 1000 | |
|---|---|---|---|---|---|---|
| Catalysts | mA/cm² (mV) | (mV/dec) | mA/cm² (mV) | mA/cm² (mV) | mA/cm² (mV) | Stability |
| Co/W₂TiC₂-700 | 63 | 44.3 | 191 | 330 | 407.72 | 500 h @10 mA/cm² |
| | | | | | | 100 h @1000 mA/cm² |
| | | | | | | 1000 h @4000 mA/cm² |
| NiFe-LDH/Ti C | 132 | 70 | — | 205 | — | 280 h @10 m A/cm² |
| T/NF | | | | | | 200 h @1000 mA/cm² |
| MoS₂@Mo₂CTₓ | 176 | 207 | — | — | — | 8 h @0.400 V |
| Ni_{0.9}Co_{0.1}@Nb- | 43.4 | 116 | — | — | — | 50 h @10 mA/cm² |
| doped Ti₃C₂Tₓ | | | | | | |
| Nb₄C₃Tₓ | 398 | 122 | — | — | — | 50 h @0.398 V |
| | | | | | | (~10 mA/cm²) |
| WP-W₂C | 43 | 42.11 | 139 | — | 560 | 40 h @350 mA/cm² |
| | | | | | | 60 h @570 mA/cm² |
| | | | | | | 60 h @1000 mA/cm² |
| Mo₂C@C | 47 | 71 | — | — | — | — |
| MoS₂—Mo₂C | 56 | 64.2 | 171 | — | 446 | — |
| HC-MoS₂/Mo₂C | — | — | — | — | 441 | 24 h @500 mA/cm² |
| MoS₂—Mo₂C | — | 43 | — | 191 | 220 | 24 h @200 mA/cm² |
| Mo₂C/MoC/carbon | 82 | 42 | — | 201 | 233 | 336 h @1000 mA/cm² |
| nanotube | | | | | | |
| MoC—Mo₂C-790 | 98.2 | 59 | — | 292 | — | 100 h @100 mA/cm² |
| | | | | | | 50 h @300 mA/cm² |
| | | | | | | 50 h @500 mA/cm² |
| | | | | | | 2400 h @1000 mA/cm² |
| Co₂P/N@Ti₃C₂Tₓ | 15 | 30 | — | — | — | 4 h @10-80 mA/cm² |
| @NF | | | | | | |
| CoP/Ti₃C₂Tₓ | 113 | 57 | — | — | — | 24 h @50 mA/cm² |
| Co₇Se₈/Ti₃C₂Tₓ | 270 | 128.5 | — | — | — | 24 h @50 mA/cm² |
| Co—CeO | — | — | 132 | 215 | — | 14 h @150 mV |
| | | | | | | (~40 mA/cm²) |
| | | | | | | 14 h @200 mV |
| | | | | | | (~70 mA/cm²) |
| Co₃Mo/Cu | 12 | 40 | 96 @ 400 mA/cm² | | | 1000 h @60 mA/cm² |
| | | | | | | 500 h @210 mA/cm² |
| Co—Mo₅N₆ | 19 | 29 | — | — | 280 | 10 h @5000 mA/cm² |
| CoP/MoP@NC/CC | 94 | 40 | — | — | 475 | — |
| CoP | — | 78 | 141 | 243 | 290 | 300 h @1000 mA/cm² |
| N—Co₂P/CC | 34 | 51 | — | — | — | — |
| Co—B—P/NF | 42 | 42.1 | — | — | 165 | 20 h @1000 mA/cm² |
| A-NiCo LDH | 36 | 57 | 151 | 286 | 381 | 72 h @1000 mA/cm² |
| | | | | | | 72 h @1000 mA/cm² |
| NiCo/NiCo—OH | 19 | 42 | 104 | 184 | — | 24 h @500 mA/cm² |
| CoSe₂@Ti₃C₂Tₓ | 230 | 65 | — | — | — | 12 h @25 mA/cm² |
| IrCo@Ti₃C₂Tₓ | 135 | 56 | — | — | — | 80 h @1.59 V |
| | | | | | | (~17 mA/cm²) |
| | | | | | | 50 h @10 mA/cm² |
| | | | | | | 200 h @100 mA/cm² |
| Mo—NiCoP/MXene | 96 | 98.34 | — | — | — | 48 h @10 mA/cm² |
| Mo-doped CoP | 181 | 76 | — | — | — | 16 h @10 mA/cm² |
| CoP-CNFs | 225 | 100.8 | — | — | — | 8 h @10 mA/cm² |
| Co₉S₈@MoS₂ | 103 | 67 | — | — | — | 16.67 h @10 mA/cm² |
| nanoflower | | | | | | |
| Co—Mo—B/NF | — | 124 | 174 | — | — | 24 h @100 mA/cm² |
| Co₃Mo₃N/Co₄N/Co | 78 | 68 | — | — | — | 100 h @200 mA/cm² |
| MoC—Mo₂C-790 | 98.2 | 59 | 183 | 292 | — | 1000 h @~30 mA/cm² |
| | | | | | | 50 h @100 mA/cm² |
| | | | | | | 50 h @300 mA/cm² |
| | | | | | | 50 h @500 mA/cm² |
| CoP—CoₓO_{y}-CC | 43 | 64.7 | — | — | — | 70 h @~25 mA/cm² |
| (Ni_{0.2}Co_{0.8})₆Mo₆C₂ | 100 | 59 | — | — | — | 48 h @1000 mA/cm² |
| Co/CoO/CNT/CF | 17 | 31 | — | 185 | — | 100 h @100 mA/cm² |
| | | | | | | 100 h @500 mA/cm² |
| | | | | | | 100 h @1000 mA/cm² |
| Ni/MoO₂@CoFeOₓ | 18 | 65 | 110 | — | — | 50 h @50 mA/cm² |
| | | | | | | 50 h @100 mA/cm² |
| | | | | | | 50 h @500 mA/cm² |
| WC-Mo₂C@CC | 122 | 61.6 | 201 | 309 | — | 100 h @500 mA/cm² |

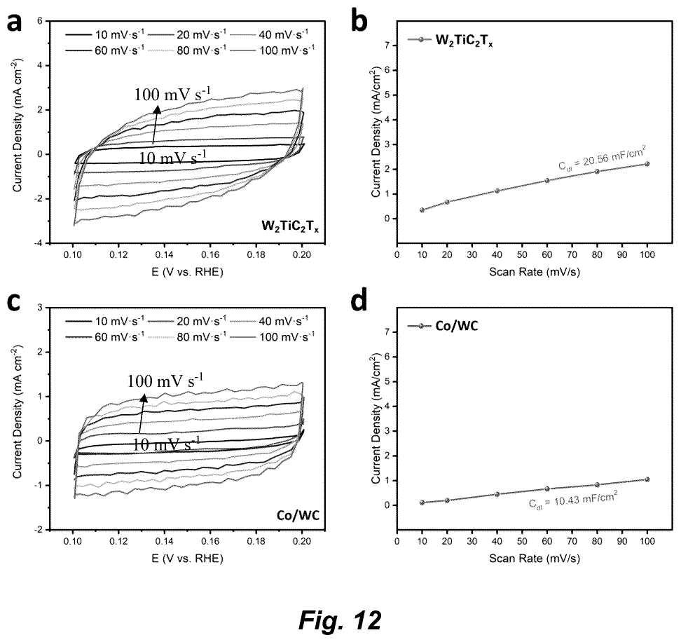

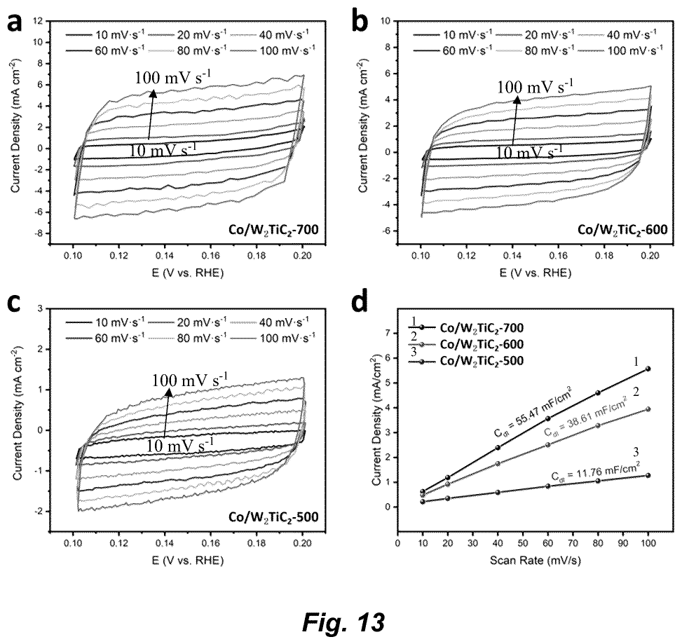

To further understand the performance of Co/W₂TiC₂ catalysts, the electrochemical active area (ECSA) was investigated by measuring the double layer capacitance (C_{d1}). Cyclic voltammograms (CV) were collected at 10 to 100 mV/s scan rates in a non-faradaic region (FIG. 12 and FIG. 13), and the C_{d1} values were calculated from the slope of charging current density differences plotted against the scan rates plots. ECSA was determined by dividing the C_{d1} by the specific capacitance (Cₛ, assumed as 40 μF/cm²). FIG. 12 showed the C_{d1} of Co/WC and W₂TiC₂Tₓ were 10.43 and 20.56 mF/cm². The higher C_{d1} of W₂TiC₂Tₓ was attributable to its inherently larger specific surface area due to the characteristic nature of two-dimensional structures. FIG. 13 showed Cai of Co/W₂TiC₂-500, 600 and 700 are 11.76, 38.61 and 55.47 mF/cm², respectively.

The decrease in C_{d1} values on Co/W₂TiC₂ compared with pure W₂TiC₂Tₓ was due to the interaction between the MXene flakes and metal precursors (Co here). The high Cai value of Co/W₂TiC₂-700 indicated that it had the largest electrochemical active area among all the three catalysts, which could be due to smaller Co nanoparticle size and relatively larger numbers of Co nanoparticle for a constant Co loading in our Co/W₂TiC₂-700 sample (as evident from Table 2). These results also hinted the active sites of Co/W₂TiC₂ were either Co NPs or the interfaces between Co NPs and W₂TiC₂ supports, which will be discussed in the next section.

Stability of the catalyst under reaction environment is one of the crucial factors in evaluating the performance of a HER catalyst for industrial-scale applications. To this end, the stability of Co/W₂TiC₂-700 was assessed by stepwise and continuous chronopotentiometry tests, as shown in FIG. 4g and FIG. 4i. In a 12-hour test, when the current densities were sequentially increased from −10 to −50 mA cm⁻² in the intervals of 4 h, the potential remained stable at each setting, and quickly returned to the original values when the current density was reduced from −50 to −10 mA cm⁻². Continuous operation at −10 mA cm⁻² showed no decrease in potential even after 500 h continuous operation. Moreover, chronopotentiometry test was further conducted under high current density of 1000 mA cm⁻², no obvious decay was found within 100 h. TEM image of Co/W₂TiC₂-700 after the 100 hours stability test in 1M KOH showed no change in morphology, highlighting the outstanding stability of Co/W₂TiC₂-700 under alkaline catalytic condition.

Effect of Co coordination environment on the HER activity and H* binding. Although the HER overpotential is a kinetic quantity, several recent studies have used H* adsorption free energies as an indicator of HER overpotential. Recent work has further shown a linear correlation between the HER activation free energy and the adsorption free energy of H* on different surfaces. We therefore evaluated adsorption free energies of H* as a means of qualitatively comparing HER overpotentials on these three materials—isolated Co (single site Co²⁺)/W₂TiC₂, W₂TiC₂, and Co NP/W₂TiC₂. Specifically, we calculated relative adsorption free energies (ΔGᵣₑₗ) for H* on different Co-modified W₂TiC₂ materials, using the corresponding value on Pt (111) as a reference:

$$Δ {G}_{rel} = {G}_{H * @ Co / {W}_{2} {TiC}_{2}} - {G}_{H * @ Pt ( 111 )} = {G}_{H *} + 0.21 eV .$$

Smaller magnitudes of ΔGᵣₑₗ indicate H* binding closer to the previously-observed HER activity peak on pure Pt. The ΔGᵣₑₗ values calculated based on the most stable binding site of H* on the respective surfaces suggested that the theoretically expected trend in the HER activity was: isolated Co/W₂TiC₂ (−0.13 eV)>W₂TiC₂ (−0.32 eV)>Co NP/W₂TiC₂ (−0.40 eV). This was contrary to our experimental data (Table 6) showing a lower overpotential on Co NP/W₂TiC₂ than on clean W₂TiC₂. Experimentally, the overpotential for W₂TiC₂ shifted by −0.24 V relative to Pt, which is in good agreement with the DFT-calculated ΔGᵣₑₗ on the clean W₂TiC₂ surface (−0.32 eV). We therefore ascribe the deviation in trend to the strong binding found on the Co NP model: the most stable H-binding site on Co NPs likely overbinds H*.

TABLE 6
Summary of HER activity catalyzed
by Co/MXene catalysts and Pt.

| | Overpotential | Overpotential |
|---|---|---|
| Samples | @ 10 mA/cm² | @ 100 mA/cm² |
| Co/W₂TiC₂-700 | 63 mV | 191 mV |
| Co/W₂TiC₂-600 | 89 mV | 232 mV |
| Co/W₂TiC₂-500 | 99 mV | 350 mV |
| Co/WC | 212 mV | 387 mV |
| W₂TiC₂ | 291 mV | 476 mV |
| Commercial 40% Pt/C | 52 mV | 238 mV |

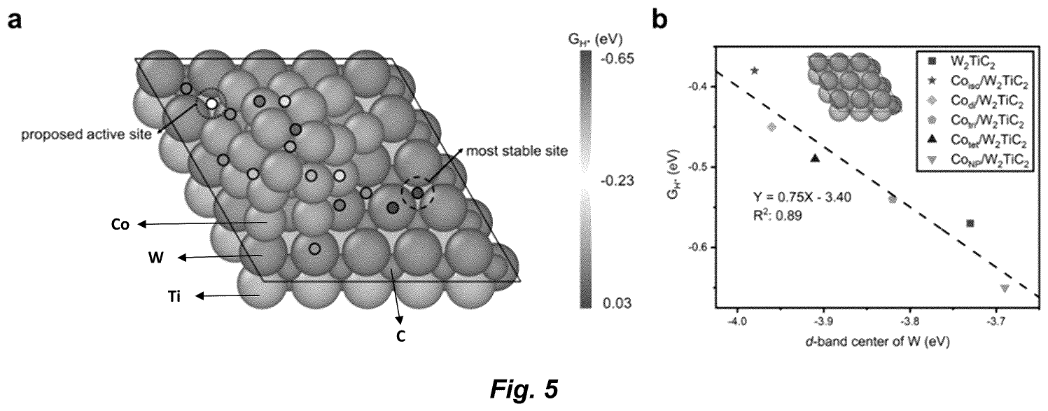

We evaluated G_{H*} at a number of possible binding sites in our computational model of Co NP/W₂TiC₂ (FIG. 5a). The most stable binding site for H*, located away from the Co NP on a W site, significantly overbinds H* (ΔGᵣₑₗ=−0.40 eV) and is likely to be inactive. However, we identified a separate type of H* binding site at the Co—W interface that is likely to exhibit a near-ideal binding strength of H* (ΔGᵣₑₗ=0.02 eV). We infer that Co—W interfacial sites are therefore the likeliest active site candidate for such particles. We do not anticipate strong interactions between H* at these sites and H* at the strongest-binding W sites, given the large distance between such sites (˜4 Å), though we note that we are not including a rigorous study of coverage effects on the Co NP itself due to the high computational cost of such studies. Further, the ΔGᵣₑₗ value of 0.02 eV for Co—W interfacial site is in good agreement with our experimental data showing a shift of +0.05 V in overpotential relative to Pt.

Accounting for these interfacial sites as most active, the theoretically expected HER activity (based on ΔGᵣₑₗ, eV) should be: Co NP/W₂TiC₂ (0.02)>isolated Co/W₂TiC₂ (−0.13)>W₂TiC₂ (−0.32), agreeing with our experimental predictions. We find that the d-band center of the interfacial W atom acts as a strong descriptor of G_{H*} across a series of models, as shown in FIG. 5b, suggesting that Co plays an important role in tuning the electronic structure of W toward favorable interactions with H*. Further discussion on the effect of Co—Co coordination environment and H* surface coverage on the H* binding strength in the low surface coverage regime is provided in Example 3.

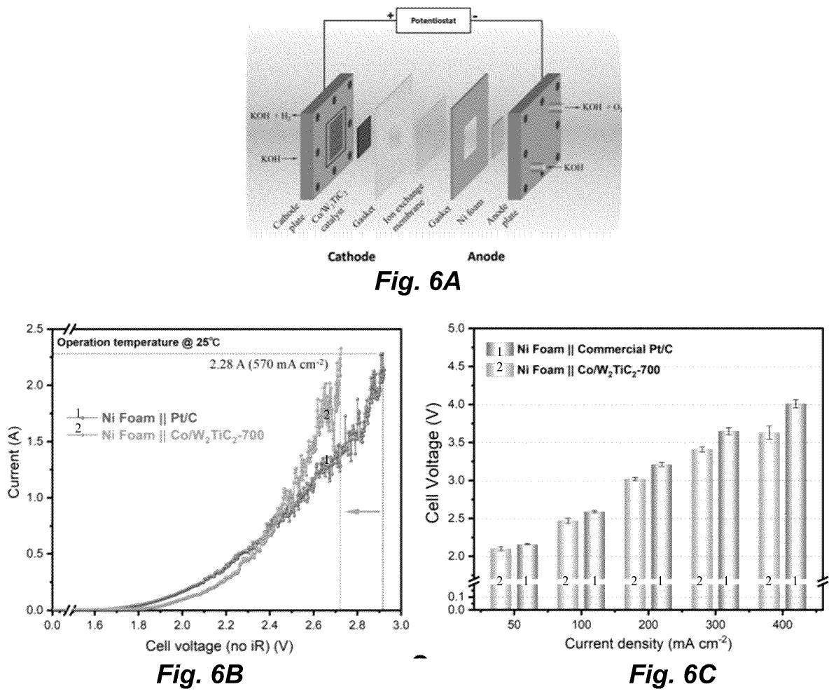

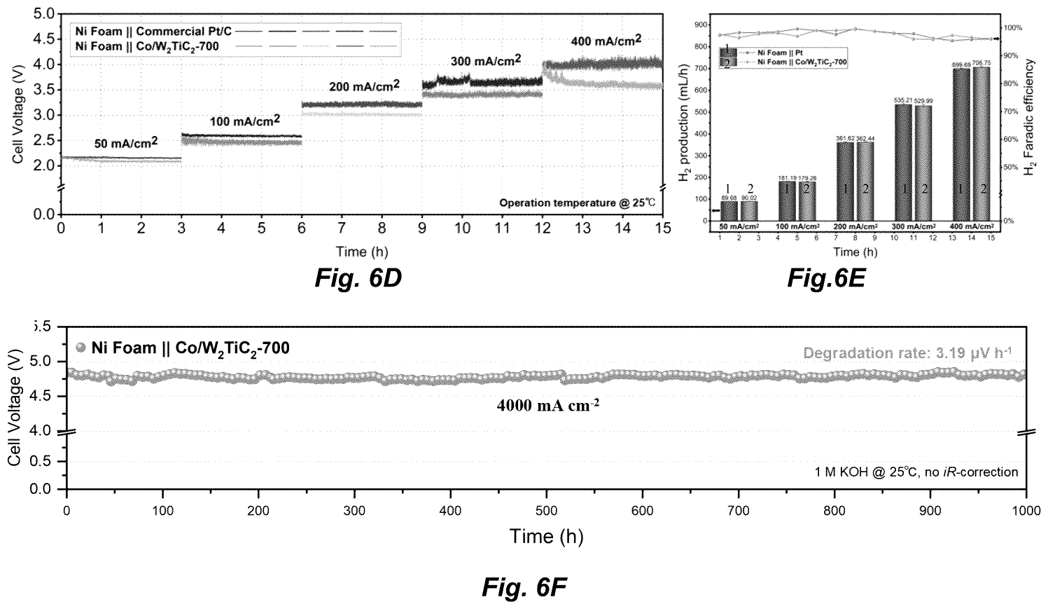

Co/W₂TiC₂ alkaline HER catalyst under industrially relevant conditions. From the temperature-induced structure modulation and metal-support interaction as well as meticulous mechanistic investigations, Co/W₂TiC₂-700 demonstrated its great potential and scientific grounding to serve as a high-performance water electrolysis catalyst. Considering the practical industrial environment applications that require high current density and the low overpotential exhibited by our Co/W₂TiC₂-700 at 1000 mA cm⁻² in linear sweep voltammetry, this optimized material was applied in a 2×2 cm² flow cell electrolyzer for alkaline water electrolysis tests and hydrogen quantification (FIG. 6a). Co/W₂TiC₂-700 was employed as the cathode, paired with non-noble metal material Ni foam as the anode on which oxygen evolution happened, and 1M KOH was used as electrolyte for both sides. Using a potentiostat with a ±2A/±30V booster, a maximum current of 1.6 A (400 mA/cm²) was applied. Linear sweep measurements revealed trends consistent with those observed in the half-cell tests, at lower current densities, the Pt/C cathode pair displayed advantage in cell voltage, however, as the potential continued to increase, the Co/W₂TiC₂-700 catalyst surpassed it and delivered higher current densities beyond 2.4 V.

As shown in FIG. 6d, a piece of Co/W₂TiC₂-700 electrode was continuously used in the cell for chronopotentiometry tests at current densities of 50, 100, 200, 300, and 400 mA cm⁻² for 3 hours each, and exhibited stable performance throughout the 15 hours of operation. The overall cell voltages of Co/W₂TiC₂-700 working as the cathode from 50 to 400 mA/cm² were all lower than that of Pt/C with comparable loading amount (0.57 mg Pt/cm²) on the identical carbon paper substrate (FIG. 6c). The lower cell voltage under the same current indicated less voltage was required to drive the electrolysis reaction beyond its thermodynamic potential, resulting from the synergistic effects of intrinsic catalytic activity, conductivity, and surface property. The hydrogen produced was quantified using on-line gas chromatography (GC), as shown in FIG. 6e. The Co/W₂TiC₂-700 catalyst achieved nearly 100% H₂ Faradaic efficiency and comparable hydrogen production rates as commercial Pt/C at the conditions of 50 to 400 mA cm⁻², with the highest hydrogen production rate of 706.75 mL/h attained at 1.6 A.

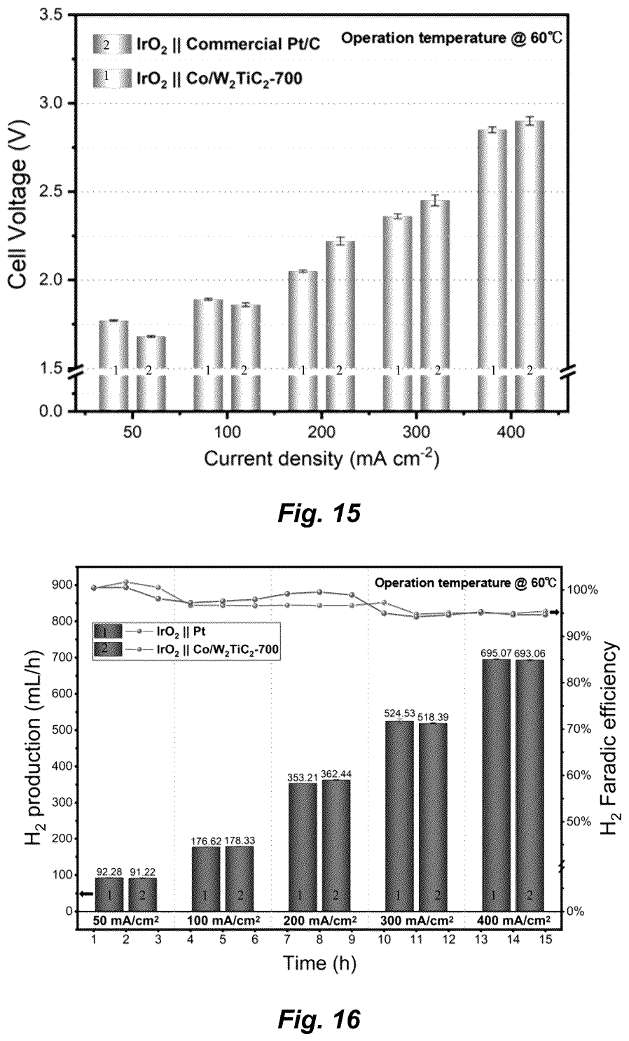

Furthermore, to verify the possibility of further reducing the cell voltage at operating conditions closer to the optimal performance parameters reported for AWE technology, IrO₂ anode and high operation temperature of 60° C. were applied to the same flow cell electrolyzer. Cell voltage was further reduced to 2.85 mV at 400 mA/cm² (FIG. 15 and FIG. 16), with lower cell voltage compared with using Pt/C observed from 100 to 400 mA cm⁻², and similar close to 100% H₂ Faradaic efficiency and close hydrogen production rates as Pt/C at all current density conditions. Energy efficiency analysis at this operation condition is provided in Example 4, the IrO₂∥Co/W₂TiC₂-700 demonstrated 46.98%-65.16% iR-free cell energy efficiency, higher than the 44.63%-56.94% of IrO₂∥Pt, substantiated its feasibility for efficient hydrogen production at practical high current applications.

To evaluate the performance of Co/W₂TiC₂-700 catalyst under industrially relevant conditions, we conducted extended durability tests at an even more demanding current density of 4000 mA cm⁻² in 1 M KOH using a 1×1 cm² flow cell configuration. Remarkably, the catalyst maintained stable operation over 1000 hours without discernible degradation in cell voltage. Post-reaction STEM characterization further revealed that the layered structure of the W₂TiC₂ MXene remained well-preserved, and the Co species remained uniformly dispersed without signs of aggregation. In addition to the catalyst's constituent elements, potassium (K) was also detected, which is likely attributed to residual KOH electrolyte adsorbed on the surface after electrolysis. This represents one of the longest-duration HER stability tests at such an ultra-high current density reported for non-noble metal-based catalysts to date.

As shown in FIG. 4f, the Co/W₂TiC₂-700 stands out by achieving an exceptional combination of low overpotential (63 mV at 10 mA cm⁻²) and ultra long-term stability at 4000 mA cm⁻² for 1000 hours, which far exceeds the stability test current densities reported for most other cobalt-based or transition metal carbide-based catalysts, which are typically tested at <1000 mA cm⁻² for less than 100 h. The robust performance under high current conditions highlights the durability of the MXene-supported Co system under harsh industrial electrolysis conditions, which can be attributed to the mechanically stable structure of W₂TiC₂Tₓ MXene and the strong metal-support interactions help to suppress Co nanoparticle agglomeration, resist structural collapse, and prevent chemical degradation during prolonged reaction. All these advantages position Co/W₂TiC₂ as a promising candidate for large-scale alkaline water electrolysis applications.

Conclusions. A novel W₂TiC₂Tₓ MXene with a well-defined W—Ti—W layered structure was successfully synthesized for the first time via a novel MAX phase, providing a robust and tunable platform for catalyst design. By anchoring Co species onto this MXene through thermal reduction, the configuration and electronic structure of Co were precisely regulated via strong metal-support interactions, leading to an evolution from isolated single sites and large NPs to uniform sub-nanometer Co NPs as confirmed by EXAFS.

With an optimized Co dispersion, the Co/W₂TiC₂-700 catalyst exhibited outstanding alkaline HER performance including low overpotential of 63 mV at 10 mA cm⁻², small Tafel slope of 44.3 mV dec⁻¹, and excellent long-term stability of 100 h at 1000 mA cm⁻². When implemented in a paired MEA flow cell electrolyzer, Co/W₂TiC₂-700 as the cathode paired with Ni foam anode in 1 M KOH demonstrated lower cell voltages than Pt/C across a wide current range (50-400 mA cm⁻²) and achieved ˜100% H₂ Faradaic efficiency over 15 hours of continuous operation. Moreover, at industrially relevant current densities, the catalyst maintained continuous operation for 1000 hours at an ultra-high current density of 4000 mA cm⁻² (4 A cm⁻²) in 1 M KOH, representing one of the highest durability benchmarks reported to date among non-precious HER catalysts. Combined with nearly 100% H₂ faradaic efficiency across a broad current range, these results underscore the excellent industrial feasibility of this catalyst. DFT calculations in conjunction with the EXFAS studies revealed that the Co—W interfacial sites as the likely active centers for HER. The hydrogen adsorption free energy (ΔG_{H*}) on these sites was found to correlate strongly with the d-band center of W, providing a promising descriptor for future catalyst design.

Overall, this work introduces a structurally novel MXene platform and demonstrates how metal-support interactions can be leveraged to engineer efficient and durable HER catalysts, providing an avenue to further extend the applications of MXene-support metal catalysts to a broad spectrum of industrially important electrocatalytic reactions.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1. Methods

Synthesis of W₂TiAlC₂ and W₂TiC₂Tₓ MXene. The W₂TiAlC₂ was synthesized by spark plasma sintering (SPS). Commercial powders of tungsten carbide (WC, 45 μm, GoodFellow Alritch, 99.5%), titanium (Ti, 325 mesh, Alfa Aesar, 99%) and aluminum (Al, 17-30 μm, Alfa Aesar, 99%) were mixed with a molar ratio of WC/Ti/Al=2:1:1.5 in a graphite die coated with boron nitride (BN). The sample in graphite die was then loaded in a Fuji-2111x spark plasma sintering (SPS) and sintered at 1200° C. under 30 MPa for 4 h. The sintered bulk W₂TiAlC₂ was pulverized in a synthetic sapphire mortar and screened through a 325-mesh sieve to fine W₂TiAlC₂ powder.

W₂TiC₂Tₓ MXene was prepared by etching W₂TiAlC₂ powder with hydrofluoric acid. 1.0 g of the obtained W₂TiC₂Tₓ MXene was added into 10 mL of hydrofluoric acid (HF, Sigma Aldrich, 48% in water) and stirred for 72 h at 55° C. in a high-density polyethylene centrifugal tube. The sample was then centrifuged and washed by deionized water (DI) until pH reached 5-6. The obtained powder was delaminated with 10 mL tetramethylammonium hydroxide (TMAOH, Acros Organics, 25% in water) at 80° C. for 12 h, followed by 6 h sonication. W₂TiC₂Tₓ MXene was collected by centrifugation at 9000 rpm and dried in vacuum. The obtained W₂TiC₂Tₓ MXene was stored in the glove box filled with N₂ for future use.

Synthesis of Co/W₂TiC₂ catalysts. Co was loaded on WC and W₂TiC₂Tₓ MXene by the incipient-wetness impregnation method. Cobalt (II) chloride (Sigma Aldrich, 98%) was dissolved with DI water to form a solution of 0.125 g Co/ml. 100 μL of CoCl₂ solution was mixed with 250 mg of W₂TiC₂Tₓ MXene powder by consisting stirring in a polyethylene weighing boat. The mixture was dried in vacuum at room temperature, then transferred into a tube furnace and reduced under 5% H₂/N₂ flow at different temperatures (500° C., 600° C., 700° C.) for 2 h with a ramping rate of 5° C. min⁻¹ and natural cooling off. The prepared Co/W₂TiC₂-500, Co/W₂TiC₂-600, and Co/W₂TiC₂-700 catalysts were stored in the glove box filled with N₂ for future use.

Characterizations. The X-ray diffraction (XRD) patterns were conducted on a Siemens D500 X-ray diffractometer with Cu Kα radiation source (λ=1.5406 Å). The simulated XRD was obtained by Material Studio and VESTA and refined using GSAS software. Field-emission scanning electron microscopy (SEM) images were acquired on FEI Quanta 250. Transmission electron microscopy (TEM) imaging was acquired on a 200 kV JEOL 2100 TEM. High-angle annular dark-field scanning transmission electron microscopy (HAADF-STEM) and energy-dispersive X-ray spectroscopy (EDS) mapping were performed using a Thermo Fisher Scientific Talos F200X S/TEM operated at 200 kV and equipped with a super-X EDS system. X-ray photoelectron spectroscopy (XPS) data was collected on a Kratos Amicus XPS instrument. Ion scattering spectroscopy (ISS) was collected on a Thermo Fisher Scientific Nexsa G2. Co K-edge X-ray absorption spectroscopy (XAS) was measured at 8-ID at the National Synchrotron Light Source II (NSLS-II) at Brookhaven National Laboratory (BNL). Samples were ground into a fine powder and added between quartz wool in Kapton sample tubes with 10 ccm He continuous flow. XAS data were fitted using the WinXAS 3.1 software package. Least-squares fit in R-space of the k²-weighted Fourier transform data from 2.6 to 11.0 Å⁻¹ was used to obtain the EXAFS coordination parameters. The first shell was used to fit the EXAFS spectra. The amplitude reduction factor (S₀²) was determined as 0.70 by fitting a reference spectrum of the Co foil and was used for fitting the other EXAFS spectra.

Electrochemical Measurements. The working electrodes were prepared by spray coating. 200 mg of catalysts were dispersed in 20 mL of isopropanol by sonication for 5 min, 20 wt % Nafion solution (LQ-1105 1100EW, 5% wt., Ion Power) was then added into the catalyst ink and sonicated for another 5 min to obtain a homogeneous ink. The prepared catalyst inks were sprayed on a 2×2 cm² area on a hydrophilic carbon paper (Freudenberg H23, Fuelcell Store) with 0.1 mg/cm² Vulcan carbon nanoparticle layer to increase the contact between catalysts and the carbon paper, the Vulcan layer was verified as inert by the polarization curve test (Table 7). The electrodes were heating at 80° C. during the spray to vaporize the isopropanol and were left on the heat plated at 80° C. for 10 min after the spray for complete drying. For comparative experiments, commercial 40% Pt/C (40% Platinum on Vulcan XC-72R, 2-3 nm, Fuelcell Store) was sprayed using the same method. The electrochemical tests are conducted in 1 M potassium hydroxide (KOH), 0.5 M sulfuric acid (H₂SO₄), and 1 M phosphate buffered saline (PBS) for evaluating HER performance in alkaline, acidic, and neutral environments, all the electrolytes are purged by N2 for 30 min.

TABLE 7
XPS spectral data of the Co—W₂TiC₂-700 sample, acquired
with a Thermo Scientific Nexsa G2 XPS/ISS, showing surface
atomic percentages of the detected elements.

| Element | W4f | Si2p | Al2s | C1s | N1s | Ti2p | O1s | F1s | Co2p |
|---|---|---|---|---|---|---|---|---|---|
| At % | 11.6 | 1.5 | 1.7 | 32.5 | 2.9 | 7.0 | 37.8 | 0.6 | 4.3 |

### Surface Elemental Quantification

The H-cell tests were carried out on an electrochemical workstation (PMC 200, AMETEK scientific instruments) using a three-electrode H-cell system, with Ag/AgCl as the reference electrode in acidic and neutral media and Hg/HgO as the reference electrode in alkaline media. A 0.5×0.5 cm² Pt foil was used as the counter electrode. Nafion membrane (Nafion-115, Fuelcell Store) pre-treated according to the type of ions transferred (K⁺ or H⁺) was used between two counterparts of the H-cell to prevent Pt contamination from the anode side. The flow cell tests were performed with a 2×2 cm² two-electrode flow cell on a Biologic SP-300 potentiostat with a ±2 A/±30 V booster. A 2×2 cm² Ni foam (1.6 mm thick, MTI corporation) was used as the counter electrode. Pre-treated Nafion membrane was used between two counterparts of the flow cell. The H₂ quantification was carried out by an SRI GC (Multiple gas analyzer #5) with TCD and FID detector. All the test potentials were converted to reversible hydrogen electrodes (RHE) and were automatically 85% IR corrected by the potentiostats.

Computational Methods. All DFT calculations were performed using non-collinear spin-polarized plane-wave DFT as implemented in the Vienna Ab initio Simulation Package (VASP). The electron-ion interactions were described by projector augmented wave (PAW) potentials, and the generalized gradient approximation (GGA-PW91) was used to describe the exchange-correlation functionals. The electron wavefunction was expanded using plane waves with an energy cutoff of 500 eV, with electronic convergence to 10⁻⁴ eV. The W₂TiC₂ surface was modeled with a single MXene “sandwich” structure in a (3×3) periodic slab, as shown in the inset image of FIG. 5b. Approximately 18 Å of vacuum separation was provided between the periodic images along the “z” dimension. All atoms were fully relaxed. A 6×6×1 Monkhorst-Pack k-point grid was used for these slab calculations. The W₂TiC₂ surface lattice parameters were optimized, resulting in a W—W in-plane distance of 2.98 Å used to construct all models. The ionic forces on each atom were converged to 0.01 eV/Å during geometric optimizations. The DFT+U approach by Dudarev was used to correct the on-site Coulomb interactions between d orbitals of Co, W, and Ti, with parameters for each of these atoms set to U−J=4 eV.

To match the concentration of Co in the experimental samples of Co/W₂TiC₂, four Co atoms were added to a (3×3) W₂TiC₂ surface in four different configurations to replicate different Co—Co coordination environments ranging from (i) isolated Co, (ii) Co dimer, (iii) Co trimer, and (iv) Co tetramer. The relative position(s) of Co atom(s) on the other side of the MXene model were varied and geometry optimizations were performed for all possible configurations to find the most stable Co arrangements for each of the four systems. The most stable geometries for each of these four different Co arrangements are shown in FIG. 13. The formation energy of a Co cluster (Eco) on the W₂TiC₂ surface at different H* coverage was referenced to the energy of Co bulk, and the energy of the most stable configuration of H* adsorbed on W₂TiC₂:

$${E}_{Co} = {E}_{4 Co * + nH * + {W}_{2} {TiC}_{2}} - {E}_{nH * + {W}_{2} {TiC}_{2}} - {E}_{Co , bulk} \qquad ( 1 )$$

Here, E_{4Co*+nH*+W}_{₂}_{TiC}_{₂} is the total energy of W₂TiC₂ with four Co atoms and “n” atoms of H*, E_{nH*+W}_{₂}_{TiC}_{₂} is the total energy of the most stable configuration of “n” H* on W₂TiC₂, and E_{Co,bulk} is the total energy of a bulk Co atom.

To find the most stable binding geometries of H*, geometry optimizations were performed for an isolated H* (i.e., 0.11 ML) at all unique surface sites. Assuming the same most stable binding site as an isolated H*, geometry optimizations were then performed for different possible configurations of H* at surface coverages varying from 0.11 to 0.44 ML, to find the most stable configuration of H* at a given surface coverage. The cumulative adsorption free energy of “n” species of H* (G_{nH*}) was referenced to the gas phase free energies of H₂ and the energy of clean slabs:

$${G}_{nH *} = ( {E}_{nH *} + Z P {E}_{nH *} - {TS}_{nH *} ) - {E}_{surf} - \frac{n}{2} ( {E}_{{H}_{2} , g} + Z P {E}_{{H}_{2} , g} - {TS}_{{H}_{2} , g} ) \qquad ( 2 )$$

Here, Eᵢ are total energies, ZPEᵢ are calculated zero-point energies, and Sᵢ are calculated entropies. Systems denoted by nH* contain “n” atoms of H* adsorbed on the surface; the subscript “g” denotes respective gas-phase quantities. E_{surf} is the total energy of the clean slab. G_{H*}, as used in this manuscript, refers to the n=1 case. The harmonic oscillator approximation was used to calculate ZPE and S. The temperature (T) was set to 298 K, in accordance with experimental conditions for electrocatalytic performance evaluation. We note that the value of the gas-phase reference energy of H₂ does not impact trends related to G_{H*} on a given material referenced to Pt (111) in FIG. 5.

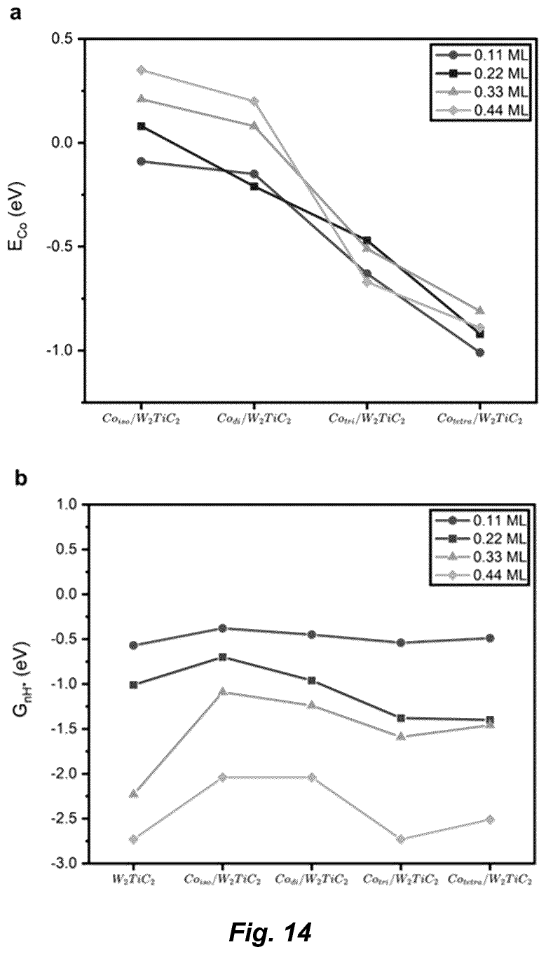

A (5×5) unit cell of W₂TiC₂ with periodic boundaries and ˜18 Å of vacuum separation between the W₂TiC₂ slabs was used for the Co nanoparticle (NP) calculations. A 4-layered Co NP with 22 Co atoms was constructed on a (5×5) unit cell of W₂TiC₂, as shown in FIG. 14, to resemble Co NPs in our experimental Co/W₂TiC₂-700 sample (Table 2). A 2×2×1 Monkhorst-Pack k-point grid was used for all the Co NP/W₂TiC₂ calculations. The remaining parameters for the DFT setup were the same as used for the slab calculations.

### Example 2. Estimation of Number of Active Sites from ECSA and Comparison with Loading Mass Derived Quantities

The electrochemical active surface area (ECSA) can be obtained from electrochemical double-layer capacitance (C_{d1}), by dividing C_{d1} by the specific capacitance for a flat standard with 1 cm² of real surface area (Cₛ). The metal plane value of smooth metal plane is generally found to be in the range of 20-60 μF cm^{-2 1}, we conservatively using 60 μF cm⁻² to estimate the number of active sites. The geometric area of the sprayed electrodes are 1×1 cm², thus ECSA of the catalysts can be calculated as:

$${A}_{ECSA ( Co / {W}_{2} {TiC}_{2} - 700 )} = ( 55.47 mF / {cm}^{2} ) \times 1 {cm}^{2} / ( 60 μF / {cm}^{2} ) = 924.5 {cm}^{2}$$

$${A}_{ECSA ( Co / {W}_{2} {TiC}_{2} - 600 )} = ( 38.61 mF / {cm}^{2} ) \times 1 {cm}^{2} / ( 60 μF / {cm}^{2} ) = 643.5 {cm}^{2}$$

$${A}_{ECSA ( Co / {W}_{2} {TiC}_{2} - 500 )} = ( 11.76 mF / {cm}^{2} ) \times 1 {cm}^{2} / ( 60 μF / {cm}^{2} ) = 196. {cm}^{2}$$

Co NP number in Co/W₂TiC₂-700 was further calculated by converting the electrochemical surface area to the number of binding sites. On this catalyst, the hydrogen is considered binding to the W atoms close to the Co—W interfaces (most stable H-binding sites marked on the DFT Co nanoparticle/W₂TiC₂ model, FIG. 5a) in the ECSA tests at non-Faradaic region, while under reaction condition, hydrogen is proposed forming at the Co—W interface sites due to the most stable W sites poisoned by strong binding of H. The specific surface area per W atom on the (111) plane of W₂TiC₂ can be calculated as: Sₐ₍₁₁₁₎=√¾×a²=3.39×10⁻¹⁶ cm^{2 2}. Thus, the number of W surface sites can be obtained as NW=ECSA/Sₐ₍₁₁₁₎. Considering the amount of such W sites adjacent to each Co particle, and the number of Co—W interface sites on each Co NP, the number of active sites can be obtained as:

$${N}_{Co - W ( ECSA )} = ( 924.5 {cm}^{2} / 3.39 \times {10}^{- 16} {cm}^{2} ) / 6 \times 3 = 1.36 \times {10}^{18}$$

The quantity of active sites was checked through calculations based on the actual loading mass of Co. Given that EXAFS analysis revealed in Co/W₂TiC₂-700 Co existing entirely in the form of nanoparticles, determination of NP amount can be to dividing the total count by the number of Co atoms within a single particle of around 0.9 nm size:

$${N}_{Co NPs ( loading mass )} = ( 0.49 mg / {cm}^{2} ) \times 1 {cm}^{2} / ( 28.01 g / mol ) \times {N}_{A} / 22 = 4.79 \times {10}^{17}$$

$${N}_{Co - W ( loading mass )} = {N}_{Co NPs} \times 3 = 1.44 \times {10}^{18}$$

In the calculation above, the N_{A} is Avogadro constant and N_{Co—W} (loading mass) stands for the active sites number directly derived from Co loading amount. The values obtained from two methods were similar (1.36×10¹⁸ and 1.44×10¹⁸), this numerical approximations derived from both methods further substantiate the specific structure of Co on W₂TiC₂.

### Example 3. Effect of Co—Co Coordination Environment and H* Surface Coverage on the H* Binding Strength

To investigate the effect of Co—Co coordination environment on the H* binding strength, DFT calculations were performed for H* coverage varying from 0.11 ML to 0.44 ML on different W₂TiC₂ surfaces (see methods section in the main text for details). We note that when geometric optimization calculations were performed with an initial guess of single H* placed symmetrically or asymmetrically on top or at the hollow sites involving Co atoms on all the considered Co/W₂TiC₂ surfaces (i.e., isolated, dimer, trimer, and tetramer of Co), H* always shifted to a different binding site (fcc site for isolated Co/W₂TiC₂ and Co dimer/W₂TiC₂; W top site for Co trimer/W₂TiC₂ and Co tetramer/W₂TiC₂). Combining these observations with the most stable binding sites of H* on respective materials, we note that H* does not prefer to bind with a single Co atom or ensemble of Co atoms, and therefore the expected active site for the HER chemistry at the isolated, dimer, trimer, and tetramer of Co on W₂TiC₂ might be the Co—W interface (same as Co NP).

FIG. 14b summarizes trends in the adsorption free energies of H* (G_{nH*}) for the most stable binding geometries across all the considered Co/W₂TiC₂ surfaces and at H* coverages ranging from 0.11 ML to 0.44 ML. The qualitative trend in the adsorption free energies across different surfaces remains same at all the considered H* coverages—H* binds weakest on isolated Co/W₂TiC₂ and strongest on the clean W₂TiC₂, with an exception at 0.22 ML H* coverage where stronger H* binding was observed on Co tetramer/W₂TiC₂ compared to that on clean W₂TiC₂ with differential adsorption free energies of 0.39 eV. Such coverage sensitive trend in the G_{nH*} across different materials indicates that the trend in the HER activity across different W₂TiC₂-based materials might be sensitive to the concentration of protons in the solution. This is evident from the significantly different experimental LSV profiles in the presence of 1 M KOH (FIG. 4a) and

0.5 M H₂SO₄ (FIG. 4b). Further, comparing the overall trend in the G_{H*} across different Co/W₂TiC₂ surfaces, H* binding becomes stronger as the Co starts aggregating, i.e., H* binds stronger on Co tetramer/W₂TiC₂ (G_{H*}: −0.49 eV) compared to that on isolated Co/W₂TiC₂ (G_{H*}: −0.38 eV). This trend in H* binding is explained by a strong correlation between G_{H*} and the d-band center of the W closest to H* (FIG. 5b). This correlation suggests that the addition of Co on W₂TiC₂ surface alters the electronic structure of the interfacial W atoms, which ultimately impacts the binding strength of H* at the Co—W interface.

### Example 4. Energy Efficiency Analysis of Flow Cell Tests

To further assess the performance of the flow cell electrolyzer using Co/W₂TiC₂ as the catalyst, the energy efficiency was calculated for the IrO2∥Co/W₂TiC₂-700 at 60° C. The equation for cell energy efficiency is:

$${η}_{e} ( Energy Efficiency ) = {η}_{v} ( Voltage Efficiency ) = {η}_{F} ( Faradaic Efficiency )$$

While energy efficiency is equal to equilibrium cell potential divided by the cell voltage. For water electrolyzer, the equilibrium cell potential is 1.229 V at room temperature (20° C.) and 1.218 V at 60° C. At 400 mA/cm², the averaged H2 faradaic efficiency in 3 h on Co/W₂TiC₂-700 is 94.88%, and cell voltage is 2.85 V, thus the energy efficiency can be calculated as:

$${η}_{e} ( 400 mA / {cm}^{2} ) = ( 1.218 V / 2.85 V ) \times 94.88 \% = 40.55 \%$$

Conventional alkaline water electrolyzers (AWE) are capable of achieving energy efficiencies ranging of 52%-69% when operating at current densities of 200-400 mA/cm^{2 3}. The primary difference is posited to be the internal resistance attributed to the cation exchange membrane (CEM) that conducts K⁺ ions as compared to the liquid potassium hydroxide (KOH) utilized in AWEs. Therefore, the internal resistance led voltage drop was subtracted from the total cell voltage and iR-free voltage was calculated. Using EIS measured internal resistance values of 0.977 Ω, 1.02Ω, and 0.967Ω, the iR-free cell voltage at 200, 300, and 400 mA/cm² are 1.85 V, 2.05 V, and 2.46 V, respectively. The corresponding energy efficiencies are:

$${η}_{e} ( 400 mA / {cm}^{2} ) = ( 1.218 V / 2.46 V ) \times 94.88 \% = 46.98 \%$$

$${η}_{e} ( 300 mA / {cm}^{2} ) = ( 1.218 V / 2.07 V ) \times 94.61 \% = 56.21 \%$$

$${η}_{e} ( 200 mA / {cm}^{2} ) = ( 1.218 V / 1.85 V ) \times 99.23 \% = 65.33 \%$$

While the iR-free ηₑ for IrO₂∥Pt at the same conditions are 44.63%, 52.08% and 58.31%. Also, the efficiency values of IrO₂∥Co/W₂TiC₂-700 after excluding the impact of internal resistance are comparable with state-of-the-art water electrolyzers, indicating the high efficiency of this catalyst in the flow cell system.

### Example 5. Additional Data

TABLE 8
Summary of HER activity catalyzed
by different Co/MXene catalysts.

| | Overpotential | | |
|---|---|---|---|
| Catalyst | @ 10 mA/cm² | Tafel slope | |
| Co/W₂TiC₂-700 | 63 mV | 44.3 | mV/dec |
| Co/W₂TiC₂-600 | 89 mV | 50.8 | mV/dec |
| Co/W₂TiC₂-500 | 99 mV | 71.0 | mV/dec |
| Co/WC | 212 mV | 166.3 | mV/dec |
| W₂TiC₂ | 291 mV | 268.0 | mV/dec |

TABLE 9
Summary of high current density HER activity
catalyzed by Co/W₂TiC₂-700 and Pt.

| Overpotential | Commercial 40% Pt/C | Co/W₂TiC₂-700 |
|---|---|---|
| η @ 10 mA/cm² | 52 mV | 63 mV |
| η @ 100 mA/cm² | 238 mV | 191 mV |
| η @ 200 mA/cm² | 312 mV | 246 mV |
| η @ 300 mA/cm² | 362 mV | 286 mV |
| η @ 400 mA/cm² | 399 mV | 309 mV |
| η @ 500 mA/cm² | 424 mV | 330 mV |
| η @ 1000 mA/cm² | 499 mV | 407 mV |

All publications, patents, and patent documents cited herein are incorporated by reference as though individually incorporated by reference. No limitations inconsistent with this disclosure are to be understood therefrom. The invention has been described with reference to various specific and preferred embodiments and techniques. However, many variations and modifications may be made while remaining within the spirit and scope of the invention.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

What is claimed is:

1. An annealed catalyst comprising a delaminated MXene support of Formula I: 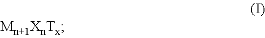
wherein
M is a combination of a middle transition metal and an early transition metal;
X is a non-metal wherein the non-metal is carbon or nitrogen;
Tₓ is a surface functional group wherein x is 0-10; and
n is 2 or 3; and
late transition metal nanoparticles having a particle size of about 0.5 nm to about 2.0 nm, wherein less than about 5 weight percent of the late transition metal nanoparticles are uniformly distributed onto a basal plane of the MXene support based on the weight of the catalyst;
wherein metal support interactions at an interface of atoms of the late transition metal nanoparticles and atoms of the middle transition metal are present in the catalyst.

2. The annealed catalyst of claim 1, wherein about 3.5 weight percent to about 4.5 weight percent of the late transition metal nanoparticles are uniformly distributed onto the MXene support.

3. The annealed catalyst of claim 1, wherein the late transition metal nanoparticles have a particle size of about 0.8 nm to about 1.0 nm.

4. The annealed catalyst of claim 1, wherein the late transition metal nanoparticles are more than about 50% metallic or less than about 50% oxidized.

5. The annealed catalyst of claim 1, wherein the late transition metal nanoparticles are about 100% metallic.

6. The annealed catalyst of claim 1, wherein the annealed catalyst was annealed at about 450° C. to about 750° C.

7. The annealed catalyst of claim 1, wherein the annealed catalyst was annealed at about 700° C.

8. The annealed catalyst of claim 1, wherein the metal support interactions are d-band metal support interactions.

9. The annealed catalyst of claim 1, wherein the late transition metal nanoparticles consist of one to five layers of its atoms positioned on the basal plane of the MXene support,

10. The annealed catalyst of claim 1, wherein the middle transition metal is tungsten; or
wherein the early transition metal is titanium; or
wherein the middle transition metal is tungsten; and the early transition metal is titanium.

11. The annealed catalyst of claim 1, wherein X is carbon and n is 2; or
wherein X is carbon, n is 2, and x is 0.

12. The annealed catalyst of claim 1, wherein the delaminated MXene support of Formula I is Formula II: 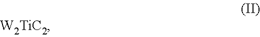
wherein the delaminated MXene support comprises a layer of tungsten atoms, a layer of carbon atoms, and a layer of titanium atoms that alternate in the sequence W—C—Ti—C to form a layer of titanium atoms in-between two layers of carbon atoms that are sandwiched together between two layers of tungsten atoms.

13. The annealed catalyst of claim 1, wherein the late transition metal nanoparticles are cobalt metal nanoparticles.

14. A delaminated MXene support of Formula I: 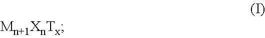
wherein
M is a combination of a middle transition metal and an early transition metal;
X is a non-metal wherein the non-metal is carbon or nitrogen;
Tₓ is a surface functional group wherein x is 0-10; and
n is 2 or 3.

15. The delaminated MXene support of claim 14, wherein the delaminated MXene support is Formula II: 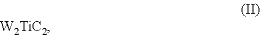
wherein the delaminated MXene support comprises a layer of tungsten atoms, a layer of carbon atoms, and a layer of titanium atoms that alternate in the sequence W—C—Ti—C to form a layer of titanium atoms in-between two layers of carbon atoms that are sandwiched together between two layers of tungsten atoms.

16. A method for an electrocatalytic hydrogen evolution reaction comprising:
a) contacting an alkaline aqueous electrolyte with a catalyst loaded onto a cathode, wherein the catalyst was annealed at about 700° C. and comprises:
i) a delaminated MXene support of Formula II: 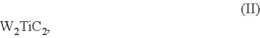
wherein the delaminated MXene support comprises a layer of tungsten atoms, a layer of carbon atoms, and a layer of titanium atoms that alternate in the sequence W—C—Ti—C to form a layer of titanium atoms in-between two layers of carbon atoms that are sandwiched together between two layers of tungsten atoms; and
ii) cobalt metal nanoparticles having a size of about 0.8 nm to about 1.0 nm, wherein about 3.5 weight percent to about 4.5 weight percent of the cobalt metal nanoparticles are uniformly distributed onto a basal plane of the MXene support based on the weight of the catalyst; and
b) applying a current to the cathode;
wherein an electrocatalytic reaction occurs at the cathode to form the evolution of hydrogen gas.

17. The method of claim 16, wherein d-band metal support interactions at an interface of atoms of the cobalt metal nanoparticles and atoms of the tungsten metal are present in the catalyst, wherein the interface is an active site for catalytic formation of hydrogen gas.

18. The method of claim 16, wherein the cobalt metal nanoparticles are about 100% cobalt(0) metal nanoparticles.

19. The method of claim 16, wherein the cathode is loaded with about 10 mg/cm² to about 15 mg/cm² of the catalyst.

20. The method of claim 16, wherein the cathode is loaded with about 0.4 mg/cm² to about 0.6 mg/cm² of the cobalt metal nanoparticles.
